(19) United States
(12) Patent Application Publication
(10) Pub. No.: US 2023/0357021 A1
(43) Pub. Date: Nov. 9, 2023

(54) SYSTEMS AND METHODS FOR PROCESSING

(71) Applicant: Monolith Materials, Inc., Lincoln, NE (US)

(72) Inventors: Robert J. Hanson, Lincoln, NE (US); Ned J. Hardman, Lincoln, NE (US); Thomas R. Maier, Lincoln, NE (US)

(21) Appl. No.: 18/295,584

(22) Filed: Apr. 4, 2023

Related U.S. Application Data
(63) Continuation of application No. PCT/US2021/053371, filed on Oct. 4, 2021.
(60) Provisional application No. 63/087,783, filed on Oct. 5, 2020.

(51) Int. Cl. C01B 32/205; C09C 1/48

(52) U.S. Cl. CPC C01B 32/205; C09C 1/485; C01P 2006/80

(57) ABSTRACT

Carbonaceous product may be generated using systems and methods provided herein. Carbon dioxide may be sequestered. The carbonaceous product may include carbon black.

### CROSS-REFERENCE

This application is a continuation of International Application No. PCT/US2021/053371, filed Oct. 4, 2021, which claims the benefit of U.S. Provisional Application No. 63/087,783, filed Oct. 5, 2020, each of which is entirely incorporated herein by reference.

### BACKGROUND

Carbonaceous product may be produced by various chemical processes. Performance, energy supply and environmental performance associated with such chemical processes has evolved over time.

### SUMMARY

The present disclosure recognizes a need for more efficient and effective processes to produce carbonaceous product, such as, for example, carbon black. Also recognized herein is a need to sequester carbon dioxide. The present disclosure may provide, for example, processes for sequestering carbon dioxide into carbonaceous product.

The present disclosure provides, for example, a carbonaceous product having a ratio of carbon-14 atoms to carbon-12 atoms greater than about 3*10\hat{ }−13. The carbonaceous product may be carbon black. Carbon atoms in the carbonaceous product may be exposed to temperatures in excess of about 1,000° C. during conversion of a hydrocarbon feedstock to the carbonaceous product. The conversion of the hydrocarbon feedstock may comprise conversion of biomethane and/or additive hydrocarbon feedstock to the carbonaceous product. The carbonaceous product may be solid. Carbon-14 content may be achieved through securing digital carbon-14 credits of biomethane, and physical carbon-14 may not be present in the carbonaceous product as made.

The present disclosure also provides, for example, a production process, wherein for every ton of input natural gas, carbon dioxide (CO₂) emissions of carbonaceous product and all other products of the production process are reduced by more than about 3 tons compared to incumbent processes for producing the carbonaceous product and all other products.

The present disclosure also provides, for example, a production process for producing carbonaceous product, wherein for every 1 ton of the carbonaceous product that is produced, at least about 2.0 tons of carbon dioxide (CO₂) are removed from the atmosphere and sequestered within the carbonaceous product and the carbonaceous product, as manufactured, subsequently comprises carbon from the CO₂. Manufacture of the carbonaceous product may sequester carbon dioxide (CO₂) from the atmosphere, and the carbonaceous product may be carbon black. The production process may further comprise producing the carbonaceous product substantially free of atmospheric oxygen. The production process may further comprise producing the carbonaceous product with the aid of electrical heating. The production process may further comprise producing the carbonaceous product with the aid of a plasma generator.

The present disclosure also provides, for example, a production process, comprising a biomethane process, a plasma process, and an ammonia process in one location. The biomethane process, the plasma process and the ammonia process may operate simultaneously. The biomethane process may produce biomethane, the plasma process may consume the biomethane produced by the biomethane process and produce a carbonaceous product and hydrogen, and the ammonia process may consume the hydrogen produced by the plasma process and produce ammonia. The production process may further comprise sharing waste heat between one or more of the biomethane process, the plasma process and the ammonia process.

The present disclosure also provides, for example, a method of processing, comprising using wind energy or other renewable energy to generate plasma in pyrolytic decomposition of methane. The pyrolytic decomposition may include pyrolytic dehydrogenation.

The present disclosure also provides, for example, a raw feed of tire crumb of less than about 10 mm by 10 mm size, wherein the raw feed of tire crumb is provided into a plasma process as a co-feed with biomethane, biofuel and/or natural gas. The plasma process may produce carbon black.

The present disclosure also provides, for example, a method of processing, comprising converting one or more tires and carbon black to methane. The method may further comprise using the methane to produce carbonaceous product. The method may further comprise producing the carbonaceous product substantially free of atmospheric oxygen. The method may further comprise producing the carbonaceous product with the aid of electrical heating. The method may further comprise producing the carbonaceous product with the aid of a plasma generator. The carbonaceous product may be carbon black.

The present disclosure also provides, for example, a rubber article having a ratio of carbon-14 atoms to carbon-12 atoms greater than about 3*10\hat{ }−13.

The present disclosure also provides, for example, a tire having a ratio of carbon-14 atoms to carbon-12 atoms greater than about 3*10\hat{ }−13.

The present disclosure also provides, for example, a feed of biomethane comprising greater than or equal to about 60% by volume of methane derived from a biological source, wherein a remainder of the feed of biomethane comprises impurities from a digestion process and/or one or more co-feedstocks, and wherein the feed of biomethane is used to produce a carbonaceous product. The one or more co-feedstocks may be (i) bio-based, (ii) not bio-based, or (iii) a combination thereof.

These and additional embodiments are further described below.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGs.” herein), of which:

FIG. 1 shows a schematic representation of an example of a process in accordance with the present disclosure;

FIG. 2 shows a schematic representation of an example of a system in accordance with the present disclosure;

FIG. 3 shows a schematic representation and approximate description of a furnace process;

FIG. 4 shows a schematic representation of an example of a process in accordance with the present disclosure;

FIG. 5 schematically illustrates certain advantages of a process in accordance with the present disclosure;

FIG. 6 shows a schematic representation of an example of a plasma process in accordance with the present disclosure;

FIG. 7 shows a schematic representation of an example of a conventional carbon black process; and

FIG. 8 shows a schematic representation of an example of a conventional ammonia process.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed. It shall be understood that different aspects of the invention can be appreciated individually, collectively, or in combination with each other.

Manufacturing is ever evolving into more sustainable and greener processes. A green process may refer, for example, to a process that reduces greenhouse gases (e.g., such as, for example, by at least about 0.1%, 0.5%, 1%, 2%, 5%, 10%, 15%, 20%, 25%, 50%, 75%, 90%, 95% or 100% compared to an existing or incumbent process). Today there is a renaissance of production methods with the next generation of green technology replacing older incumbent technologies. While some effect may be achieved by making new materials via green processes, the most powerful effect may be felt by replacing existing manufacturing technology and existing products with greener technologies that are not only greener but also cost competitive and additionally provide a useful product that performs as good or better than the incumbent product.

The present disclosure provides examples of such systems and methods, including, for example, the use of plasma technology in the pyrolytic decomposition (e.g., pyrolytic dehydrogenation) of natural gas to carbon black and hydrogen (also “plasma process” herein). Pyrolytic decomposition (e.g., pyrolytic dehydrogenation) may refer to thermal decomposition of materials at elevated temperatures in an inert or oxygen-free or substantially oxygen-free atmosphere (e.g., an oxygen-free environment or atmosphere may be, for example, as described elsewhere herein). Pyrolysis may refer, for example, to temperatures greater than about 800° C. Carbon black and hydrogen may be the useful co-products in this instance. A core aspect of this technology may be fewer CO₂, SOₓ and/or NOₓ emissions. As the technology evolves, the true spirit of the capabilities of this inventive technology may come to the forefront (e.g., through upstream and/or downstream configuration of the process). For example, the process may include upstream and/or downstream configuration in terms of CO₂ reduction and/or CO₂ net sequestration (e.g., the most efficient process may entail upstream and downstream optimization in terms of CO₂ reduction, and indeed, CO₂ net sequestration).

An ideal next generation green process may entail the sequestering of CO₂ into the form of a carbonaceous product that is industrially useful, environmentally friendly, and provides products that are stable in the environment for long periods of time. The resultant carbonaceous product may (e.g., ideally) be recycled through multiple product lifecycles.

The present disclosure provides systems and methods for affecting chemical changes. Affecting such chemical changes may include making carbonaceous product (e.g., carbon particles, such as, for example, carbon black) using the systems and methods of the present disclosure. The systems (e.g., apparatuses) and methods of the present disclosure, and processes implemented with the aid of the systems and methods herein, may sequester carbon dioxide. The systems (e.g., apparatuses) and methods of the present disclosure, and processes implemented with the aid of the systems and methods herein, may allow continuous production of, for example, carbon black or carbon-containing compounds (also “carbonaceous product” herein). The systems and methods described herein may enable continuous operation and production of, for example, high quality carbon particles (e.g., carbon black). The processes may include converting a carbon-containing feedstock. The systems and methods described herein may include heating hydrocarbons rapidly to form, for example, carbon particles (e.g., carbon black). For example, the hydrocarbons may be heated rapidly to form carbon particles (e.g., carbon black) and hydrogen. Hydrogen may in some cases refer to majority hydrogen. For example, some portion of this hydrogen may also contain methane (e.g., unspent methane) and/or various other hydrocarbons (e.g., ethane, propane, ethylene, acetylene, benzene, toluene, polycyclic aromatic hydrocarbons (PAH) such as naphthalene, etc.).

The processes herein may include heating a thermal transfer gas (e.g., a plasma gas) with electrical energy (e.g., from a DC or AC source). The thermal transfer gas may be heated by an electric arc. The thermal transfer gas may be heated by Joule heating (e.g., resistive heating, induction heating, or a combination thereof). The thermal transfer gas may be heated by Joule heating and by an electric arc (e.g., downstream of the Joule heating). The thermal transfer gas may be heated by heat exchange, by Joule heating, by an electric arc, or any combination thereof. The thermal transfer gas may be heated by heat exchange, by Joule heating, by combustion, or any combination thereof. The process may further include mixing injected feedstock with the heated thermal transfer gas (e.g., plasma gas) to achieve suitable reaction conditions. The hydrocarbon may be mixed with the hot gas to affect removal of hydrogen from the hydrocarbon. The products of reaction may be cooled, and the carbon particles (e.g., carbon black) or carbon-containing compounds may be separated from the other reaction products. The as-produced hydrogen may be recycled back into the reactor.

The thermal transfer gas may in some instances be heated in an oxygen-free environment. The carbonaceous product (e.g., carbon particles) may in some instances be produced (e.g., manufactured) in an oxygen-free atmosphere. An oxygen-free atmosphere may comprise, for example, less than about 5% oxygen by volume, less than about 3% oxygen (e.g., by volume), or less than about 1% oxygen (e.g., by volume).

The thermal transfer gas may comprise at least about 60% hydrogen up to about 100% hydrogen (by volume) and may further comprise up to about 30% nitrogen, up to about 30% CO, up to about 30% CH₄, up to about 10% HCN, up to about 30% C₂H₂, and up to about 30% Ar. For example, the thermal transfer gas may be greater than about 60% hydrogen. Additionally, the thermal transfer gas may also comprise polycyclic aromatic hydrocarbons such as anthracene, naphthalene, coronene, pyrene, chrysene, fluorene, and the like. In addition, the thermal transfer gas may have benzene and toluene or similar monoaromatic hydrocarbon components present. For example, the thermal transfer gas may comprise greater than or equal to about 90% hydrogen, and about 0.2% nitrogen, about 1.0% CO, about 1.1% CH₄, about 0.1% HCN and about 0.1% C₂H₂. The thermal transfer gas may comprise greater than or equal to about 80% hydrogen and the remainder may comprise some mixture of the aforementioned gases, polycyclic aromatic hydrocarbons, monoaromatic hydrocarbons and other components. Thermal transfer gas such as oxygen, nitrogen, argon, helium, air, hydrogen, carbon monoxide, hydrocarbon (e.g., methane, ethane, unsaturated) etc. (used alone or in mixtures of two or more) may be used. The thermal transfer gas may comprise greater than or equal to about 50% hydrogen by volume. The thermal transfer gas may comprise, for example, oxygen, nitrogen, argon, helium, air, hydrogen, hydrocarbon (e.g. methane, ethane) etc. (used alone or in mixtures of two or more). The thermal transfer gas may comprise greater than about 70% H₂ by volume and may include at least one or more of the gases HCN, CH₄, C₂H₄, C₂H₂, CO, benzene or polyaromatic hydrocarbon (e.g., naphthalene and/or anthracene) at a level of at least about 1 ppm. The polyaromatic hydrocarbon may comprise, for example, naphthalene, anthracene and/or their derivatives. The polyaromatic hydrocarbon may comprise, for example, methyl naphthalene and/or methyl anthracene. The thermal transfer gas may comprise a given thermal transfer gas (e.g., among the aforementioned thermal transfer gases) at a concentration (e.g., in a mixture of thermal transfer gases) greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by weight, volume or mole. Alternatively, or in addition, the thermal transfer gas may comprise the given thermal transfer gas at a concentration (e.g., in a mixture of thermal transfer gases) less than or equal to about 100%, 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4.5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by weight, volume or mole. The thermal transfer gas may comprise additional thermal transfer gases (e.g., in a mixture of thermal transfer gases) at similar or different concentrations. Such additional thermal transfer gases may be selected, for example, among the aforementioned thermal transfer gases not selected as the given thermal transfer gas. The given thermal transfer gas may itself comprise a mixture. The thermal transfer gas may have at least a subset of such compositions before, during and/or after heating.

The hydrocarbon feedstock may include any chemical with formula CₙHₓ or CₙHₓO_{y}, where n is an integer; x is between (i) 1 and 2n+2 or (ii) less than 1 for fuels such as coal, coal tar, pyrolysis fuel oils, and the like; and y is between 0 and n. The hydrocarbon feedstock may include, for example, simple hydrocarbons (e.g., methane, ethane, propane, butane, etc.), aromatic feedstocks (e.g., benzene, toluene, xylene, methyl naphthalene, pyrolysis fuel oil, coal tar, coal, heavy oil, oil, bio-oil, bio-diesel, biomethane, biofuel, other biologically derived hydrocarbons, and the like), unsaturated hydrocarbons (e.g., ethylene, acetylene, butadiene, styrene, and the like), oxygenated hydrocarbons (e.g., ethanol, methanol, propanol, phenol, ketones, ethers, esters, and the like), or any combination thereof. These examples are provided as non-limiting examples of acceptable hydrocarbon feedstocks which may further be combined and/or mixed with other components for manufacture. A hydrocarbon feedstock may refer to a feedstock in which the majority of the feedstock (e.g., more than about 50% by weight) is hydrocarbon in nature. The reactive hydrocarbon feedstock may comprise at least about 70% by weight methane, ethane, propane or mixtures thereof. The hydrocarbon feedstock may comprise or be natural gas. The hydrocarbon may comprise or be methane, ethane, propane or mixtures thereof. The hydrocarbon may comprise methane, ethane, propane, butane, acetylene, ethylene, carbon black oil, coal tar, crude coal tar, diesel oil, benzene and/or methyl naphthalene. The hydrocarbon may comprise (e.g., additional) polycyclic aromatic hydrocarbons. The hydrocarbon feedstock may comprise one or more simple hydrocarbons, one or more aromatic feedstocks, one or more unsaturated hydrocarbons, one or more oxygenated hydrocarbons, or any combination thereof. The hydrocarbon feedstock may comprise, for example, methane, ethane, propane, butane, pentane, natural gas, benzene, toluene, xylene, ethylbenzene, naphthalene, methyl naphthalene, dimethyl naphthalene, anthracene, methyl anthracene, other monocyclic or polycyclic aromatic hydrocarbons, carbon black oil, diesel oil, pyrolysis fuel oil, coal tar, crude coal tar, coal, heavy oil, oil, bio-oil, bio-diesel, biomethane, biofuel, other biologically derived hydrocarbons, ethylene, acetylene, propylene, butadiene, styrene, ethanol, methanol, propanol, phenol, one or more ketones, one or more ethers, one or more esters, one or more aldehydes, or any combination thereof. The feedstock may comprise one or more derivatives of feedstock compounds described herein, such as, for example, benzene and/or its derivative(s), naphthalene and/or its derivative(s), anthracene and/or its derivative(s), etc. The hydrocarbon feedstock (also “feedstock” herein) may have a composition as described elsewhere herein. Bio-waste/organic waste, recycled/recyclable products and/or other such materials may also be used as feedstocks. Such feedstocks may be converted or transformed, as described in greater detail elsewhere herein.

A hydrocarbon feedstock (also “feedstock” herein) may comprise a feedstock mixture. The feedstock may comprise a first feedstock (e.g., methane, natural gas, biomethane or biofuel) and one or more additional (e.g., second, third, fourth, fifth, etc.) feedstocks (e.g., ethane, propane, butane, pentane, benzene, toluene, xylene, ethylbenzene, naphthalene, methyl naphthalene, dimethyl naphthalene, anthracene, methyl anthracene, other monocyclic or polycyclic aromatic hydrocarbons, carbon black oil, diesel oil, pyrolysis fuel oil, coal tar, crude coal tar, coal, heavy oil, oil, bio-oil, bio-diesel, other biologically derived hydrocarbons, ethylene, acetylene, propylene, butadiene, styrene, ethanol, methanol, propanol, phenol, one or more ketones, one or more ethers, one or more esters, one or more aldehydes, or any combination thereof). A given feedstock (e.g., the first feedstock, the second feedstock, the third feedstock, the fourth feedstock, the fifth feedstock, etc.) may itself comprise a mixture (e.g., such as natural gas). The feedstock may comprise at least one of the one or more additional feedstocks without the first feedstock (e.g., the feedstock may comprise ethane, ethylene, carbon black oil, pyrolysis fuel oil, coal tar, crude coal tar or heavy oil). The feedstock may comprise the first feedstock (e.g., methane, natural gas, biomethane or biofuel) at a concentration greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by weight, volume or mole. As an alternative, the feedstock may comprise the first feedstock (e.g., methane, natural gas, biomethane or biofuel) at a concentration less than about 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4.5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by weight, volume or mole. In some examples, the feedstock may comprise the first feedstock (e.g., methane, natural gas, biomethane or biofuel) at a concentration greater than or equal to about 25%, 50%, 75%, 95% or 99%. The feedstock may comprise various levels of the additional feedstock(s). For example, the feedstock may comprise a second feedstock and a third feedstock. The feedstock may comprise the second feedstock at a concentration greater than or equal to about 1 ppm, 5 ppm, 10 ppm, 25 ppm, 50 ppm, 0.0100, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by weight, volume or mole. As an alternative, the feedstock may comprise the second feedstock at a concentration less than about 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4.5%, 4%, 3.5%, 3%, 2.5%, 2%, 1.9%, 1.8%, 1.7, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by weight, volume or mole. The feedstock may comprise the second feedstock in combination with at least the third feedstock, the third feedstock being at a concentration greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by weight, volume or mole. As an alternative, the feedstock may comprise the second feedstock in combination with at least the third feedstock, the third feedstock being at a concentration less than about 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4.5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by weight, volume or mole. The feedstock may comprise the third feedstock without the second feedstock. The second feedstock may be selected, for example, among the aforementioned first feedstocks not selected as the first feedstock and the aforementioned one or more additional feedstocks. The third feedstock may then be suitably selected from the remainder of the first feedstocks and the one or more additional feedstocks. The feedstock may comprise other (e.g. fourth, fifth, sixth, seventh, ninth, tenth, 11^{th}, 12^{th}, 13^{th}, 14^{th}, 15^{th}, 16^{th}, 17^{th}, 18th, 19^{th}, 20^{th}, etc.) additional feedstocks (e.g., at similar or different concentrations). Such other additional feedstocks may be selected, for example, among the aforementioned first feedstocks and one or more additional feedstocks not selected as the first feedstock, the second feedstock or the third feedstock. The one or more additional (e.g., second, third, fourth, fifth, etc.) feedstocks may in some instances be referred to herein as “additives.” For example, a feedstock may comprise a feedstock mixture comprising biomethane or biofuel and one or more additives (e.g., which may be hydrocarbon feedstocks as described elsewhere herein, for example, in relation to the one or more additional feedstocks). As described in greater detail elsewhere herein, biomethane or biofuel may contain a given level of carbon-14 isotopes. In some examples, the one or more additives may also be bio-derived or recycled products that were once bio-derived as these may also have a similar (e.g., the same) carbon-14 to carbon-12 ratio. Biomethane or biofuel may be combined with an additive which may also be bio-derived, such as, for example, biodiesel and the like, or which may be from petroleum products (e.g., the additive may be any of the hydrocarbon feedstocks described herein and may also be bio-derived or recycled products that were once bio-derived), or any combination thereof. Biofuel may refer to (e.g., broadly cover) any feedstock (e.g., all feedstocks) described herein (e.g., including feedstock(s) that are from petroleum or fossil fuel-generated) that may be used in a process of the present disclosure (e.g., the plasma process) and that are additionally bio-based and contain, for example, between about 3*10\hat{ }−13 and about 1.40*10\hat{ }−12 carbon-14 atoms for every one carbon-12 atom (or have a ratio of carbon-14 atoms to carbon-12 atoms as described elsewhere herein).

Different feedstocks may in some cases be replaced or mixed. This may accommodate, for example, variability in feedstock supply (e.g., decreasing availability of a given feedstock; and/or changing composition of natural gas, and/or other feedstocks such as, for example, landfill/waste gas, refinery gas streams (e.g., refinery off-gas), coal bed methane, etc.). If a given feedstock is predetermined, it may be provided separately or converted from another feedstock. Such feedstock conversion may be provided as part of the systems and methods described herein (e.g., as described elsewhere herein, for example, in relation to conversion of bio-waste/organic waste and in relation to conversion of a recycled/recyclable product). The systems (e.g., apparatuses) and methods of the present disclosure, and processes implemented with the aid of the systems and methods herein, may be configured to allow the use of one or more different feedstocks.

At least a portion of the feedstock may be further converted or generated by conversion from another feedstock. The feedstock may be further converted or generated through one or more steps or stages. For example, one or more feedstocks for biomethane may be converted to generate biomethane. Examples of materials that may be used as feedstock(s) for biomethane may include, but are not limited to, sewage, sewage waste, sewage sludge, manure, forest residue(s), agricultural residue(s), waste crops, crop residue(s), crops, waste groceries, spoiled food, and the like (or any combination thereof). For example, a feedstock for biomethane may be sewage, sewage waste or sewage sludge as such material may be rich in digestible organic material and also readily available as a zero-value stream.

Biomethane may (e.g., typically) be produced via an anaerobic digestion which may (e.g., at this point) be considered a very mature process that is well understood and continuously improving via the addition of catalysts, exploration of new temperature regimes in addition to the continuous improvement of the enzymes and bacteria that are used to break down the waste products into methane, etc. The steps of anaerobic digestion may include hydrolysis where enzymes break down and liquefy the smaller molecules and additionally break down the larger polymeric species. Acidogenesis may be a second step where the monomers from the first step are fermented to form volatile fatty acids. The next step may be where acetogenic bacteria break down the fatty acids from the previous step into useful molecules for methanogenesis such as acetic acid and hydrogen. The next step may be methanogenesis where bacteria take the next step of converting precursor molecules into methane and carboxylic acid. All of these steps may require specific reaction conditions including, for example, solution pH and temperature.

Feedstock conversion may be configured to achieve a given feedstock purity or composition. For example, one or more conversion steps or stages may be added to achieve a given purity. A low purity feedstock may be used at least in some configurations. For example, low purity biomethane or biofuel may (e.g., also) be utilized in a process according to the present disclosure (e.g., in a plasma process as described herein). It may not be necessary to remove, for example, the nitrogen, oxygen, hydrogen, hydrogen sulfide, ammonia, and/or water that is present in small quantities in (e.g., along with the) biomethane or biofuel. For example, about 60% of the biomethane or biofuel may be hydrocarbon in nature and the other impurities may not significantly affect the process.

A recyclable product may refer to any end-use product that may be recycled into another product. For example, tires may be mechanically ground into small particles that may be used in asphalt and also in playgrounds or as other filler material. See description of a tire in Mark, Erman and Roland, “The Science and Technology of Rubber,” 4^{th} Ed., incorporated by reference herein with respect to relevant portions therein.

Feedstock conversion may include, for example, thermolytic decomposition. An example of thermolytic decomposition which may optionally be accompanied by anaerobic digestion may include tire recycling (or tire recycle). The conversion of tires into methane may first begin with granulation of the tire through the use of a shredder. The shredder may reduce the size of the tire through several iterative steps to particles that are, for example, less than 1 mm by 1 mm in size. This shredded material may be passed through a magnetic separator to remove the metallic components, and/or alternatively the bead and radial components of the tire may be removed prior to shredding. This organic material may be heated in combination with a catalyst in order to provide gaseous vapor comprising (e.g., some portion of) CH₄ and other volatile organics, which may be used as a hydrocarbon feedstock in a process according to the present disclosure (e.g., provided directly into the plasma technology as the hydrocarbon feedstock). Additionally, the heat required for the decomposition of the tire crumb may be provided by recycled heat or as waste heat from the plasma process such that more full utilization of the heat generated, for example, during the conversion of the hydrocarbon feedstock to solid carbonaceous product may be achieved.

The present disclosure provides heat integration of one or more of the conversion steps or stages (or processes) with each other and/or with one or more material streams (e.g., flows) to/from one or more conversion steps or stages (or processes). Heat integration of one or more of the conversion steps or stages (or processes) with each other may include heat integration of one or more material flows to/from such conversion steps or stages (or processes). For example, waste heat sharing between different conversion steps or stages (or processes) may be implemented (e.g., waste heat may be shared between the process of generating the carbonaceous product, and one or more other processes).

The thermal transfer gas may be provided to the system (e.g., to a reactor, such as, for example, reactor 102 or 212 described herein) at a rate of, for example, greater than or equal to about 1 normal cubic meter/hour (Nm³/hr), 2 Nm³/hr, 5 Nm³/hr, 10 Nm³/hr, 25 Nm³/hr, 50 Nm³/hr, 75 Nm³/hr, 100 Nm³/hr, 150 Nm³/hr, 200 Nm³/hr, 250 Nm³/hr, 300 Nm³/hr, 350 Nm³/hr, 400 Nm³/hr, 450 Nm³/hr, 500 Nm³/hr, 550 Nm³/hr, 600 Nm³/hr, 650 Nm³/hr, 700 Nm³/hr, 750 Nm³/hr, 800 Nm³/hr, 850 Nm³/hr, 900 Nm³/hr, 950 Nm³/hr, 1,000 Nm³/hr, 2,000 Nm³/hr, 3,000 Nm³/hr, 4,000 Nm³/hr, 5,000 Nm³/hr, 6,000 Nm³/hr, 7,000 Nm³/hr, 8,000 Nm³/hr, 9,000 Nm³/hr, 10,000 Nm³/hr, 12,000 Nm³/hr, 14,000 Nm³/hr, 16,000 Nm³/hr, 18,000 Nm³/hr, 20,000 Nm³/hr, 30,000 Nm³/hr, 40,000 Nm³/hr, 50,000 Nm³/hr, 60,000 Nm³/hr, 70,000 Nm³/hr, 80,000 Nm³/hr, 90,000 Nm³/hr or 100,000 Nm³/hr. Alternatively, or in addition, the thermal transfer gas may be provided to the system (e.g., to the reactor) at a rate of, for example, less than or equal to about 100,000 Nm³/hr, 90,000 Nm³/hr, 80,000 Nm³/hr, 70,000 Nm³/hr, 60,000 Nm³/hr, 50,000 Nm³/hr, 40,000 Nm³/hr, 30,000 Nm³/hr, 20,000 Nm³/hr, 18,000 Nm³/hr, 16,000 Nm³/hr, 14,000 Nm³/hr, 12,000 Nm³/hr, 10,000 Nm³/hr, 9,000 Nm³/hr, 8,000 Nm³/hr, 7,000 Nm³/hr, 6,000 Nm³/hr, 5,000 Nm³/hr, 4,000 Nm³/hr, 3,000 Nm³/hr, 2,000 Nm³/hr, 1,000 Nm³/hr, 950 Nm³/hr, 900 Nm³/hr, 850 Nm³/hr, 800 Nm³/hr, 750 Nm³/hr, 700 Nm³/hr, 650 Nm³/hr, 600 Nm³/hr, 550 Nm³/hr, 500 Nm³/hr, 450 Nm³/hr, 400 Nm³/hr, 350 Nm³/hr, 300 Nm³/hr, 250 Nm³/hr, 200 Nm³/hr, 150 Nm³/hr, 100 Nm³/hr, 75 Nm³/hr, 50 Nm³/hr, 25 Nm³/hr, 10 Nm³/hr, 5 Nm³/hr or 2 Nm³/hr. The thermal transfer gas may be provided to the system (e.g., to the reactor) at such rates in combination with one or more feedstock flow rates described herein.

The feedstock (e.g., hydrocarbon) may be provided to the system (e.g., to a reactor, such as, for example, reactor 102 or 212 described herein) at a rate of, for example, greater than or equal to about 50 grams per hour (g/hr), 100 g/hr, 250 g/hr, 500 g/hr, 750 g/hr, 1 kilogram per hour (kg/hr), 2 kg/hr, 5 kg/hr, 10 kg/hr, 15 kg/hr, 20 kg/hr, 25 kg/hr, 30 kg/hr, 35 kg/hr, 40 kg/hr, 45 kg/hr, 50 kg/hr, 55 kg/hr, 60 kg/hr, 65 kg/hr, 70 kg/hr, 75 kg/hr, 80 kg/hr, 85 kg/hr, 90 kg/hr, 95 kg/hr, 100 kg/hr, 150 kg/hr, 200 kg/hr, 250 kg/hr, 300 kg/hr, 350 kg/hr, 400 kg/hr, 450 kg/hr, 500 kg/hr, 600 kg/hr, 700 kg/hr, 800 kg/hr, 900 kg/hr, 1,000 kg/hr, 1,100 kg/hr, 1,200 kg/hr, 1,300 kg/hr, 1,400 kg/hr, 1,500 kg/hr, 1,600 kg/hr, 1,700 kg/hr, 1,800 kg/hr, 1,900 kg/hr, 2,000 kg/hr, 2,100 kg/hr, 2,200 kg/hr, 2,300 kg/hr, 2,400 kg/hr, 2,500 kg/hr, 3,000 kg/hr, 3,500 kg/hr, 4,000 kg/hr, 4,500 kg/hr, 5,000 kg/hr, 6,000 kg/hr, 7,000 kg/hr, 8,000 kg/hr, 9,000 kg/hr or 10,000 kg/hr. Alternatively, or in addition, the feedstock (e.g., hydrocarbon) may be provided to the system (e.g., to the reactor) at a rate of, for example, less than or equal to about 10,000 kg/hr, 9,000 kg/hr, 8,000 kg/hr, 7,000 kg/hr, 6,000 kg/hr, 5,000 kg/hr, 4,500 kg/hr, 4,000 kg/hr, 3,500 kg/hr, 3,000 kg/hr, 2,500 kg/hr, 2,400 kg/hr, 2,300 kg/hr, 2,200 kg/hr, 2,100 kg/hr, 2,000 kg/hr, 1,900 kg/hr, 1,800 kg/hr, 1,700 kg/hr, 1,600 kg/hr, 1,500 kg/hr, 1,400 kg/hr, 1,300 kg/hr, 1,200 kg/hr, 1,100 kg/hr, 1,000 kg/hr, 900 kg/hr, 800 kg/hr, 700 kg/hr, 600 kg/hr, 500 kg/hr, 450 kg/hr, 400 kg/hr, 350 kg/hr, 300 kg/hr, 250 kg/hr, 200 kg/hr, 150 kg/hr, 100 kg/hr, 95 kg/hr, 90 kg/hr, 85 kg/hr, 80 kg/hr, 75 kg/hr, 70 kg/hr, 65 kg/hr, 60 kg/hr, 55 kg/hr, 50 kg/hr, 45 kg/hr, 40 kg/hr, 35 kg/hr, 30 kg/hr, 25 kg/hr, 20 kg/hr, 15 kg/hr, 10 kg/hr, 5 kg/hr, 2 kg/hr, 1 kg/hr, 750 g/hr, 500 g/hr, 250 g/hr or 100 g/hr.

The thermal transfer gas may be heated to and/or the feedstock may be subjected to (e.g., exposed to) a temperature of greater than or equal to about 1,000° C., 1,100° C., 1,200° C., 1,300° C., 1,400° C., 1,500° C., 1,600° C., 1,700° C., 1,800° C., 1,900° C., 2,000° C., 2050° C., 2,100° C., 2,150° C., 2,200° C., 2,250° C., 2,300° C., 2,350° C., 2,400° C., 2,450° C., 2,500° C., 2,550° C., 2,600° C., 2,650° C., 2,700° C., 2,750° C., 2,800° C., 2,850° C., 2,900° C., 2,950° C., 3,000° C., 3,050° C., 3,100° C., 3,150° C., 3,200° C., 3,250° C., 3,300° C., 3,350° C., 3,400° C. or 3,450° C. Alternatively, or in addition, the thermal transfer gas may be heated to and/or the feedstock may be subjected to (e.g., exposed to) a temperature of less than or equal to about 3,500° C., 3,450° C., 3,400° C., 3,350° C., 3,300° C., 3,250° C., 3,200° C., 3,150° C., 3,100° C., 3,050° C., 3,000° C., 2,950° C., 2,900° C., 2,850° C., 2,800° C., 2,750° C., 2,700° C., 2,650° C., 2,600° C., 2,550° C., 2,500° C., 2,450° C., 2,400° C., 2,350° C., 2,300° C., 2,250° C., 2,200° C., 2,150° C., 2,100° C., 2050° C., 2,000° C., 1,900° C., 1,800° C., 1,700° C., 1,600° C., 1,500° C., 1,400° C., 1,300° C., 1,200° C. or 1,100° C. The thermal transfer gas may be heated to such temperatures by a thermal generator (e.g., a plasma generator). The thermal transfer gas may be electrically heated to such temperatures by the thermal generator (e.g., the thermal generator may be driven by electrical energy). Such thermal generators may have suitable powers.

Carbon atoms in a carbonaceous product may be exposed, for example, to the aforementioned temperatures during conversion of the hydrocarbon feedstock to the carbonaceous product. For example, the carbon atoms in the carbonaceous product may be exposed to such temperatures as the reaction temperature during the conversion process of the feedstock (e.g., biomethane and/or additive hydrocarbon feedstock) to the carbonaceous product. Reaction temperature may refer to a final average temperature that may be calculated, for example, by assuming that (e.g., all) input (e.g., heat and/or electrical) energy is transferred to the thermal transfer gas (e.g., into hydrogen) and then transferred to the feedstock (e.g., natural gas and/or biomethane) given incoming thermal temperature, endothermic reaction energy, specific heat capacity, etc.

Thermal generators may operate at suitable powers. The power may be, for example, greater than or equal to about 0.5 kilowatt (kW), 1 kW, 1.5 kW, 2 kW, 5 kW, 10 kW, 25 kW, 50 kW, 75 kW, 100 kW, 150 kW, 200 kW, 250 kW, 300 kW, 350 kW, 400 kW, 450 kW, 500 kW, 550 kW, 600 kW, 650 kW, 700 kW, 750 kW, 800 kW, 850 kW, 900 kW, 950 kW, 1 megawatt (MW), 1.05 MW, 1.1 MW, 1.15 MW, 1.2 MW, 1.25 MW, 1.3 MW, 1.35 MW, 1.4 MW, 1.45 MW, 1.5 MW, 1.6 MW, 1.7 MW, 1.8 MW, 1.9 MW, 2 MW, 2.5 MW, 3 MW, 3.5 MW, 4 MW, 4.5 MW, 5 MW, 5.5 MW, 6 MW, 6.5 MW, 7 MW, 7.5 MW, 8 MW, 8.5 MW, 9 MW, 9.5 MW, 10 MW, 10.5 MW, 11 MW, 11.5 MW, 12 MW, 12.5 MW, 13 MW, 13.5 MW, 14 MW, 14.5 MW, 15 MW, 16 MW, 17 MW, 18 MW, 19 MW, 20 MW, 25 MW, 30 MW, 35 MW, 40 MW, 45 MW, 50 MW, 55 MW, 60 MW, 65 MW, 70 MW, 75 MW, 80 MW, 85 MW, 90 MW, 95 MW or 100 MW. Alternatively, or in addition, the power may be, for example, less than or equal to about 100 MW, 95 MW, 90 MW, 85 MW, 80 MW, 75 MW, 70 MW, 65 MW, 60 MW, 55 MW, 50 MW, 45 MW, 40 MW, 35 MW, 30 MW, 25 MW, 20 MW, 19 MW, 18 MW, 17 MW, 16 MW, 15 MW, 14.5 MW, 14 MW, 13.5 MW, 13 MW, 12.5 MW, 12 MW, 11.5 MW, 11 MW, 10.5 MW, 10 MW, 9.5 MW, 9 MW, 8.5 MW, 8 MW, 7.5 MW, 7 MW, 6.5 MW, 6 MW, 5.5 MW, 5 MW, 4.5 MW, 4 MW, 3.5 MW, 3 MW, 2.5 MW, 2 MW, 1.9 MW, 1.8 MW, 1.7 MW, 1.6 MW, 1.5 MW, 1.45 MW, 1.4 MW, 1.35 MW, 1.3 MW, 1.25 MW, 1.2 MW, 1.15 MW, 1.1 MW, 1.05 MW, 1 MW, 950 kW, 900 kW, 850 kW, 800 kW, 750 kW, 700 kW, 650 kW, 600 kW, 550 kW, 500 kW, 450 kW, 400 kW, 350 kW, 300 kW, 250 kW, 200 kW, 150 kW, 100 kW, 75 kW, 50 kW, 25 kW, 10 kW, 5 kW, 2 kW, 1.5 kW or 1 kW.

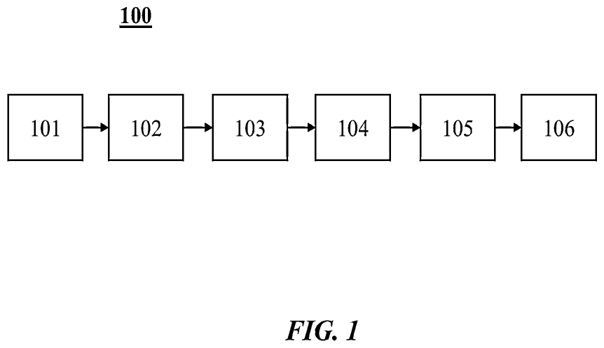

FIG. 1 shows an example of a flow chart of a process 100. The process may begin through addition of hydrocarbon to hot gas (e.g., heat+hydrocarbon) 101. The process may include one or more of the steps of heating the gas (e.g., thermal transfer gas), adding the hydrocarbon to the hot gas (e.g., 101), passing through a furnace or reactor 102, and using one or more of a heat exchanger 103 (e.g., connected to the reactor), filter (e.g., a main filter) 104 (e.g., connected to the heat exchanger), degas (e.g., degas chamber or apparatus) 105 (e.g., connected to the filter) and back end 106. As non-limiting examples of other components, a conveying process, a process filter, cyclone, classifier and/or hammer mill may be added (e.g., optionally). The back end equipment 106 may include, for example, one or more of a pelletizer (e.g., connected to the degas apparatus), a binder mixing tank (e.g., connected to the pelletizer), and a dryer (e.g., connected to the pelletizer). The back end of the reactor may comprise a pelletizer, a dryer and/or a bagger as non-limiting example(s) of components. More components or fewer components may be added or removed. Carbon particles (e.g., black) may also pass through classifiers, hammer mills and/or other size reduction equipment (e.g., so as to reduce the proportion of grit in the product).

The hot gas may be a stream of hot gas at an average temperature of over about 2,200° C. The hot gas may have a composition as described elsewhere herein (e.g., the hot gas may comprise greater than 50% hydrogen by volume). The process may include heating a gas (e.g., comprising 50% or greater by volume hydrogen) and then adding this hot gas to a hydrocarbon at 101. Heat may (e.g., also) be provided through latent radiant heat from the wall of the reactor. This may occur through heating of the walls via externally provided energy or through the heating of the walls from the hot gas. The heat may be transferred from the hot gas to the hydrocarbon feedstock. This may occur immediately upon addition of the hydrocarbon feedstock to the hot gas in the reactor or the reaction zone 102. A “reactor” may refer to an apparatus (e.g., a larger apparatus comprising a reactor section (or a reaction chamber or a reaction zone)), or to the reactor section (or a reaction chamber or a reaction zone). The hydrocarbon may begin to crack and decompose before being fully converted into carbonaceous product (e.g., carbon particles such as, for example, carbon black). The reaction products may be cooled after manufacture. A quench may be used to cool the reaction products. For example, a quench comprising a majority of hydrogen gas may be used. The quench may be injected in the reactor portion of the process. A heat exchanger may be used to cool the process gases. In the heat exchanger, the process gases may be exposed to a large amount of surface area and thus allowed to cool, while the product stream may be simultaneously transported through the process.

An effluent stream of gases and carbon particles (e.g., carbon black particles) may be (e.g., subsequently) passed through a filter which may allow more than 50% of the gas to pass through, capturing substantially all of the carbon particles (e.g., carbon black particles) on the filter. At least about 98% by weight of the carbon particles (e.g., carbon black particles) may be captured on the filter. The carbon particles (e.g., carbon black) with residual gas may (e.g., subsequently) pass through a degas apparatus where the amount of combustible gas is reduced (e.g., to less than about 10% by volume). The carbon particles (e.g., carbon black particles) may be (e.g., subsequently) mixed with water with a binder and then formed into pellets, followed by removal of the majority of the water in a dryer.

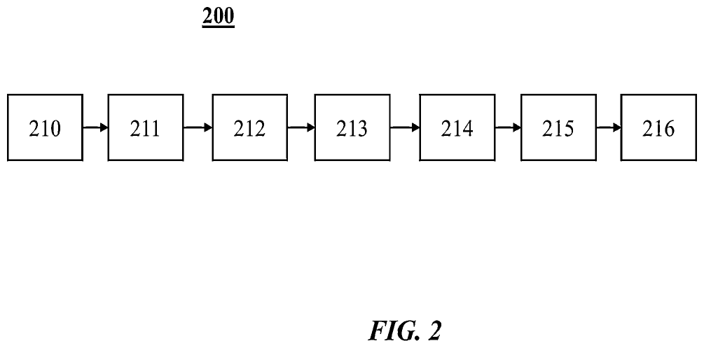

FIG. 2 shows an example of a system 200. The system may include a thermal generator (e.g., a plasma generator) 210 that generates hot gas (e.g., plasma) to which a feedstock (e.g., a feedstock gas, such as, for example, methane) 211 may be added (e.g., at a feedstock gas inlet). The mixed gases may enter into a reactor 212 where the carbonaceous product (e.g., carbon particles, such as, for example, carbon black) are generated followed by a heat exchanger 213. Carbon particles (e.g., carbon black) may then be filtered at filter 214, pelletized in a pelletizer 215 and dried in a dryer 216. Other unit operations may exist, for example, between the filter and pelletizer units shown, or elsewhere as predetermined or appropriate (e.g., as described elsewhere herein). They may include, for example, hydrogen/tail gas removal units, conveying units, process filter units, classification units, grit reduction mill units, purge filter units (e.g., which may filter black out of steam vented from dryer), dust filter units (e.g., which may collect dust from other equipment), off quality product blending units, etc.

The injected hydrocarbon may be cracked such that at least about 80% by moles of the hydrogen originally chemically attached through covalent bonds to the hydrocarbon may be homoatomically bonded as diatomic hydrogen. Homoatomically bonded may refer to the bond being between two atoms that are the same (e.g., as in diatomic hydrogen or H₂). C—H may be a heteroatomic bond. A hydrocarbon may go from heteroatomically bonded C—H to homoatomically bonded H—H and C—C. This may just refer to the H₂ from the CH₄ or other hydrocarbon feedstock (e.g., the H₂ from the plasma may still be present).

Carbonaceous product (e.g., carbon particles) may be generated at a yield (e.g., yield based upon feedstock conversion rate, based on total hydrocarbon injected, on a weight percent carbon basis, or as measured by moles of product carbon vs. moles of reactant carbon) of, for example, greater than or equal to about 1%, 5%, 10%, 25%, 50%, 55%, 60%, 65%, 70%, 75%, 80%, 85%, 90%, 91%, 92%, 93%, 94%, 95%, 96%, 97%, 98%, 99%, 99.5% or 99.9%. Alternatively, or in addition, the carbonaceous product (e.g., carbon particles) may be generated at a yield (e.g., yield based upon feedstock conversion rate, based on total hydrocarbon injected, on a weight percent carbon basis, or as measured by moles of product carbon vs. moles of reactant carbon) of, for example, less than or equal to about 100%, 99.9%, 99.5%, 99%, 98%, 97%, 96%, 95%, 94%, 93%, 92%, 91%, 90%, 85%, 80%, 75%, 70%, 65%, 60%, 55%, 50%, 25% or 5%.

The carbonaceous product may be traced back to the starting hydrocarbon. The starting hydrocarbon (also “feedstock” herein) may be, for example, from a recycled source that began with biofuel and/or it may also be biomethane or biofuel itself. The biomethane or biofuel may be, for example, made from sewage, waste organic food, cellulosic waste and the like. The biomethane or biofuel may contain a given (e.g., the appropriate) level of carbon-14 isotopes (e.g., a ratio of carbon-14 atoms to carbon-12 atoms of approximately 1.35*10\hat{ }−12, greater than about 3*10\hat{ }−13, between about 1.40*10\hat{ }−12 and about 3*10\hat{ }−13, or as described in elsewhere herein). The biomethane or biofuel may be traced back to the plant or other living organism that exchanged air with the atmosphere in order to incorporate CO₂ at the proper level of carbon-14. In this way the carbonaceous product may have a level of carbon-14 present that is different than other carbonaceous products that have substantially zero carbon-14 because these other carbonaceous products are made from fossil fuels that have long since had the carbon-14 depleted to levels of less than about 10\hat{ }−20 in terms of the atomic ratio of carbon-14 (¹⁴C) to carbon-12 (¹²C).

Biomethane may also be referred to as renewable natural gas (RNG) or sustainable natural gas (SNG). The biomethane may comprise methane. The biomethane may be a natural gas that comprises methane (e.g., at a concentration of about 90% or greater). The biomethane may have a ratio of carbon-14 atoms to carbon-12 atoms of at least about 1.35*10\hat{ }−12 (e.g., the biomethane may have an amount of carbon-14 isotope in a quantity of at least about 1.35*10\hat{ }−12:1 compared to carbon-12.

Carbon-14 is an isotope of carbon that possesses 6 protons and 8 neutrons. The half-life of carbon-14 is about 5,730 years which is why it can be used to “carbon date” any organic material. Any living organism may have a ratio of carbon-14 atoms to carbon-12 atoms of, for example, about 1.40*10\hat{ }−12 (e.g., a carbon-12 to carbon-14 ratio of approximately 1:1.40*10\hat{ }−12), or as described elsewhere herein. The amount of carbon-14 atoms in living organisms may track the amount of carbon-14 in the atmosphere, which under normal circumstances may be stable. The carbon-14 to carbon-12 radioisotope ratio may change in the presence of nuclear activity (e.g., nuclear detonation activity may potentially double or even triple the amount of carbon-14 in the atmosphere).

Principal techniques to measure carbon-14 may include gas proportional counting, liquid scintillation counting, and accelerator mass spectrometry. The conventional technique that is widely used is gas proportional counting and more can be learned about this technique through reference material such as “Radiocarbon after four decades,” pages 184-197 edited by B. Kromer and K. Munnich (including the references cited therein), which is incorporated by reference herein with respect to relevant portions therein.

A feedstock (e.g., a single feedstock or a mixture of feedstocks, as described in greater detail elsewhere herein) and/or a carbonaceous product of the present disclosure may have a ratio of carbon-14 atoms to carbon-12 atoms of, for example, greater than or equal to about 10\hat{ }−20, 10\hat{ }−19, 10\hat{ }−18, 10\hat{ }−17, 10\hat{ }−16, 10\hat{ }−15, 10\hat{ }−14, 10\hat{ }−13, 2*10\hat{ }−13, 3*10\hat{ }−13, 4*10\hat{ }−13, 5*10\hat{ }−13, 6*10\hat{ }−13, 7*10\hat{ }−13, 8*10\hat{ }−13, 9*10\hat{ }−13, 10\hat{ }−12, 1.1*10\hat{ }−12, 1.2*10\hat{ }−12, 1.3\hat{ }10\hat{ }−12, 1.35*10\hat{ }−12 or 1.4*10\hat{ }−12. Alternatively, or in addition, the feedstock (e.g., a single feedstock or a mixture of feedstocks, as described in greater detail elsewhere herein) and/or the carbonaceous product of the present disclosure may have a ratio of carbon-14 atoms to carbon-12 atoms of, for example, less than or equal to about 1.4*10\hat{ }−12, 1.35*10\hat{ }−12, 1.3\hat{ }10\hat{ }−12, 1.2*10\hat{ }−12, 1.1*10\hat{ }−12, 10\hat{ }−12, 9*10\hat{ }−13, 8*10\hat{ }−13, 7*10\hat{ }−13, 6*10\hat{ }−13, 5*10\hat{ }−13, 4*10\hat{ }−13, 3*10\hat{ }−13, 2*10\hat{ }−13, 10\hat{ }−13, 10\hat{ }−14, 10\hat{ }−15, 10\hat{ }−16, 10\hat{ }−17, 10\hat{ }−18, 10\hat{ }−19 or 10\hat{ }−20. A feedstock (e.g., a single feedstock or a mixture of feedstocks, as described in greater detail elsewhere herein) and/or a carbonaceous product of the present disclosure may have a ratio of carbon-14 atoms to carbon-12 atoms of, for example, greater than about 3*10\hat{ }−13. A feedstock (e.g., a single feedstock or a mixture of feedstocks, as described in greater detail elsewhere herein) and/or a carbonaceous product of the present disclosure may have a ratio of carbon-14 atoms to carbon-12 atoms of, for example, about 1.35*10\hat{ }−12. A feedstock (e.g., a single feedstock or a mixture of feedstocks, as described in greater detail elsewhere herein) and/or a carbonaceous product of the present disclosure may have a ratio of carbon-14 atoms to carbon-12 atoms of, for example, between about 1.40*10\hat{ }−12 and about 3*10\hat{ }−13. A feedstock (e.g., a single feedstock or a mixture of feedstocks, as described in greater detail elsewhere herein) and/or a carbonaceous product of the present disclosure may have a ratio of carbon-14 atoms to carbon-12 atoms of, for example, greater than or equal to about 10\hat{ }−20.

A process in accordance with the present disclosure may produce a carbonaceous product. The carbonaceous product may have a carbon content of, for example, greater than or equal to about 75%, 80%, 85%, 90%, 91%, 92%, 93%, 94% or 95% (e.g., by weight). Alternatively, or in addition, the carbonaceous product may have a carbon content of, for example, less than or equal to about 99%, 95%, 94%, 93%, 92%, 91%, 90%, 85% or 80% (e.g., by weight). In some examples, the carbonaceous product may comprise or be, for example, greater than or equal to about 80% or 90% carbon (e.g., about 90% or greater carbon) (e.g., by weight). Examples of this type of product may include coke, needle coke, graphite, large ring polycyclic aromatic hydrocarbons, activated carbon, carbon black, etc. (or any combination thereof). A carbonaceous product may include carbon particles. Any description of carbon particles herein may equally apply to a carbonaceous product at least in some configurations, and vice versa. Any description of carbon black herein may equally apply to one or more other carbonaceous products at least in some configurations, and vice versa.

A carbonaceous product (e.g., carbon black) may be used in various applications. For example, the carbonaceous product may be used in a rubber article. A rubber article may be an article that comprises an elastomer and one or more other ingredients. For example, the rubber article may comprise an elastomer and (e.g., normally) one or more of the other ingredients that are added during polymer-filler incorporation (also known as polymer-filler mixing), such as, for example: a filler such as carbon black or silica, an oil, ZnO, hydrogen peroxide or reaction products therefrom, sulfur, benzensulfenamides or other accelerator(s) such as thiurams, stearic acid or other organic acid, and other such ingredients such as listed in Mark, Erman and Roland, “The Science and Technology of Rubber,” 4^{th} Ed., incorporated by reference herein with respect to relevant portions therein.

An incumbent process for a given material may refer to a process by which more than about 30% of the world's production of this given material or commodity is produced over a 10-year rolling average.

For example, in the carbon black industry, over about 90% of the world's supply is produced via the furnace process. See description of furnace black process in Donnet, “Carbon Black,” 2^{nd} Ed., incorporated by reference herein with respect to relevant portions therein.

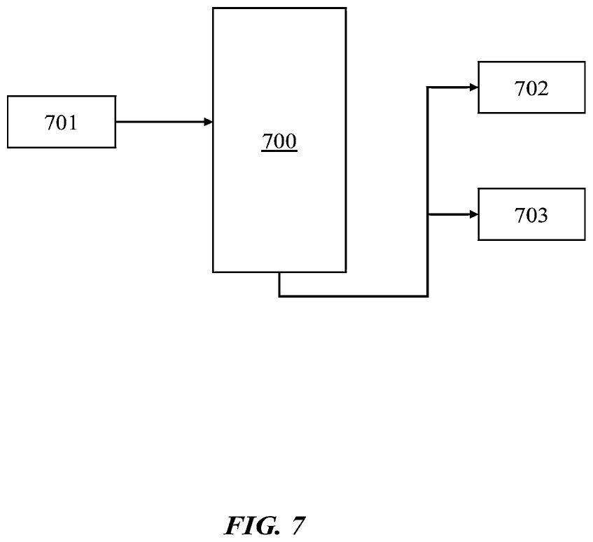

FIG. 7 shows a schematic representation of an example of a conventional carbon black process. Decant oil 701 is provided as a feedstock to a combustion process 700. The process produces carbon black (a product) 702 and CO₂, NOₓ and SOₓ 703.

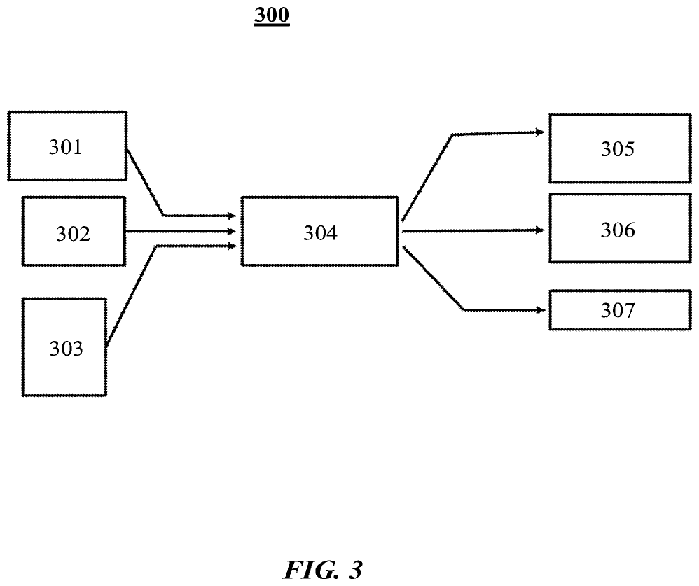

FIG. 3 shows a schematic representation and approximate description of a furnace process 300. Natural gas 301 (e.g., about 0.2 ton natural gas), pyrolysis fuel oil (PFO), which is a common feedstock in the furnace process), 302 (e.g., about 2 tons of PFO), and air (e.g., nitrogen, oxygen and various other components) 303 (e.g., about 4 tons of air at standard temperature and pressure (STP)) may be provided to a partial combustion process 304. The partial combustion process 320 may produce N₂ 305 (e.g., about 2 tons of N₂), CO₂, SOₓ and NOₓ 306 (e.g., about 3 tons of CO₂, SOₓ and NOₓ) and carbon black 307 (e.g., about 1 ton of carbon black). See description of partial combustion reactor in Donnet, “Carbon Black,” 2^{nd}Ed., incorporated by reference herein with respect to relevant portions therein.

The incumbent process for production of ammonia from hydrogen is the Haber-Bosch process. The incumbent process for hydrogen production to feed into the ammonia or Haber-Bosch process is steam methane reforming (SMR). SMR requires input of water and CH₄ according to the following equation: 2H₂O+CH₄→CO₂+4H₂. This is an energy intensive process as the reaction requires high temperatures in excess of 700° C. to proceed. In contrast, the generation of H₂ in a process in accordance with the present disclosure (e.g., the plasma technology process) may lack by-product CO₂ which in the incumbent process for making ammonia is a very large driver of global CO₂ emissions at greater than 1% of total emissions (e.g., greater than 1% of global emissions of CO₂).

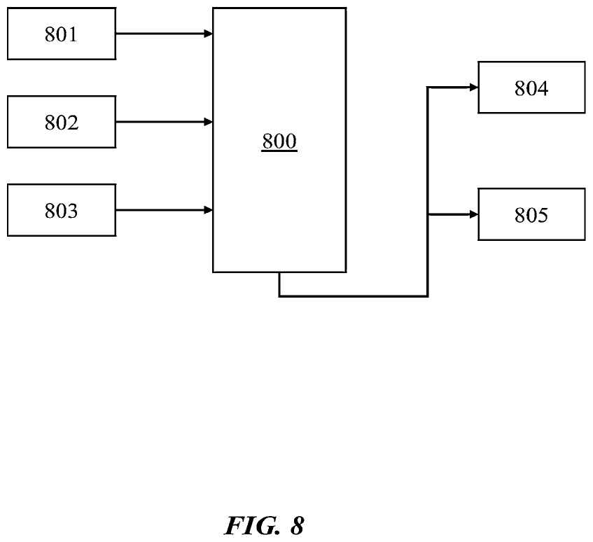

FIG. 8 shows a schematic representation of an example of a conventional ammonia process. Air 801, steam 802 and natural gas 803 are provided as feedstocks to a reforming and synthesis process 800. The process produces ammonia (a product) 804 and CO₂ 805.

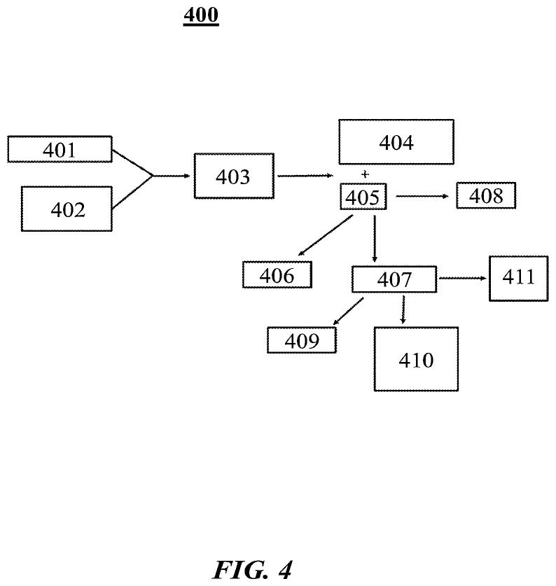

FIG. 4 shows a schematic representation of an example of a process 400 in accordance with the present disclosure. A feedstock (e.g., biomethane) 401 and energy (e.g., renewable energy) 402 may be provided to a conversion process 403 (e.g., a plasma process as described elsewhere herein). The conversion process 403 (e.g., a plasma process as described herein) may use (e.g., be configured to use) a combination of renewable energy and biomethane or biofuel (e.g., as a combination of renewable energy 402 and biomethane 401. The conversion process 403 (e.g., a plasma process as described herein) may be used (e.g., be configured for use) in conjunction with renewable energy and biomethane or biofuel. The renewable energy in this case may be, for example, wind or solar or any other number of renewable energy resources (or any combination thereof). The conversion process 403 (e.g., plasma process) may be as described elsewhere herein. The process 400 (e.g., from the conversion process 403) may produce one or more products (e.g., two or more co-products), such as, for example, a carbonaceous product 404 and hydrogen (H₂) 405. The carbonaceous product may be as described elsewhere herein. For example, the carbonaceous product may be carbon black. The carbon black may be loaded into railcars and immediately delivered to customers. The hydrogen (or a hydrogen-rich stream) may be provided or coupled to one or more uses 406 (e.g., jet fuel), 407 (e.g., ammonia) and 408 (e.g., other). Examples of such uses may include, but are not limited to, for example, providing the hydrogen to a pipeline, reinjecting the hydrogen into a pipeline, providing the hydrogen to a refinery (e.g., for use in refining operations, such as, for example, for hydrogenation), using the hydrogen in a combined or simple cycle gas turbine or steam turbine (e.g., as a combustible fuel), utilizing the hydrogen in production of ammonia (e.g., in a Haber-Bosch process to produce ammonia), utilizing the hydrogen in production of methanol (e.g., in catalytic conversion to methanol), and/or liquefying the hydrogen (e.g., to produce liquid hydrogen through liquefaction). For example, the hydrogen may be sold as hydrogen or it may be further processed into one or more chemicals including, for example, ammonia 407. Ammonia may be used, for example, as a fertilizer in the agriculture industry. For example, ammonia may be provided or coupled to one or more uses 409 (e.g., energy), 410 (e.g., urea and other chemical) and 411 (e.g., agriculture) and/or other uses (not shown).

As described, for example, in relation to FIG. 3 and FIG. 4, a process (e.g., plasma technology) in accordance with the present disclosure may be used in conjunction with biomethane and renewable energy to produce one or more products (also “co-products” herein in some contexts including multiple products), such as, for example, a carbonaceous product (e.g., carbon black) and hydrogen. The process may produce substantially zero local emissions. There may be substantially zero local emissions at the manufacturing plant (e.g., the manufacturing plant that operates on the process). Thus, for every ton of carbonaceous product (e.g., carbon black) that is generated, at least about 2 tons (e.g., circa 2 tons) of CO₂ are not emitted. Because the biomethane comes from an organism, the carbon (e.g., from the CO₂) may be sequestered as a recyclable product. The co-product hydrogen may be used to generate ammonia as one non-limiting example or provided or coupled to one or more other uses described herein.

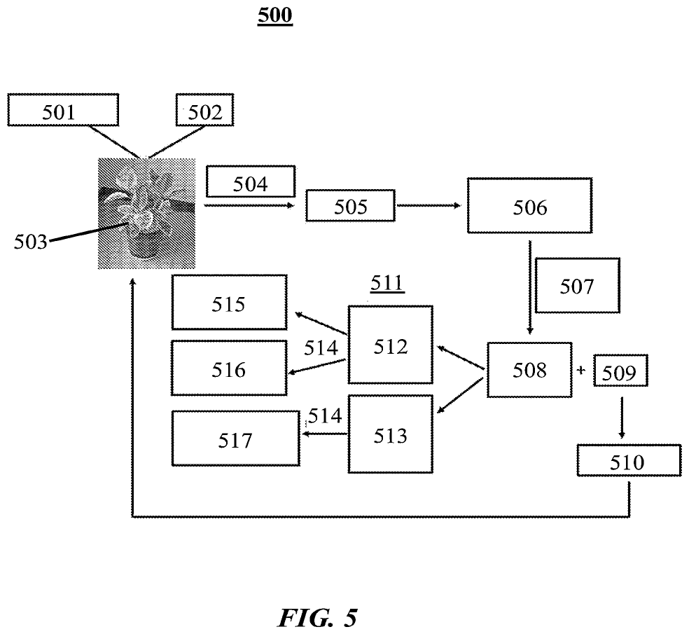

FIG. 5 schematically illustrates certain advantages of a process 500 in accordance with the present disclosure. For example, FIG. 5 illustrates ability of a conversion process (e.g., the plasma technology or the plasma process) that allows for use of biomethane or other biofuels. Energy (e.g., sunlight) 501 and carbon dioxide (CO₂) 502 may allow a plant or tree or other living organism to grow and form biomass 503. The biomass 503 may be harvested at 504 and then in the process of being utilized may become waste food or waste biomass. This material may end up, for example in sewage or other bio-waste, organic waste or biogenic waste (e.g., as described elsewhere herein) 505. The bio-waste (e.g., sewage) may then be further processed into biofuel or biomethane 506 through anaerobic digestion and then provided to a conversion process in accordance with the present disclosure (e.g., the plasma process) 507 to form one or more products, such as, for example, a carbonaceous product 508 such as, for example, carbon black, and hydrogen (H₂) 509. The hydrogen 509 may be provided or coupled to one or more uses, as described in greater detail elsewhere herein. For example, the hydrogen 509 may be transformed into ammonia 510. The ammonia 510 may further be used as a fertilizer to restart the process of growing plants to further sequester CO₂ out of the atmosphere. The carbonaceous product 508 may be, for example, carbon black. The carbonaceous product 508 (e.g., carbon black) may be used to form first generation products 511 (e.g., carbon black elastomer or plastic composites such as, for example, carbon black/rubber 512 and/or carbon black/plastics 513). The first generation products 511 (e.g., both of the classes of products shown in FIG. 5) may be recycled at 514 (e.g., to playground filler 515, asphalt filler 516 and/or recycled black plastic 517), furthering the sequestration of the as produced carbonaceous product from CO₂ from the atmosphere.

A green production process in accordance with FIG. 5 may enable manufacture of a carbonaceous product such as, for example, carbon black, that effectively sequesters CO₂ out of the atmosphere. For example, for every 1 ton of carbonaceous product such as, for example, carbon black, that is produced, at least about 2.0 tons of CO₂ may be removed from the atmosphere and sequestered within a carbonaceous product (e.g., such that the as-manufactured carbonaceous product now comprises the carbon component from the CO₂).

With continued reference to FIG. 5, governing equations for a process for forming, for example, biogenic carbon black and hydrogen may be:

6CO₂₊₆H₂O→C₆H₁₂O₆+6O₂ (photosynthesis)

C₆H₁₂O₆→3CO₂₊₃CH₄ (anaerobic digestion)

3CH₄→3C+6H₂ (pyrolysis)

Overall

6CO₂+6H₂O→6O₂+3CO₂+3C+6H₂

Reduced Equation:

CO₂+2H₂O→2O₂+C+2H₂

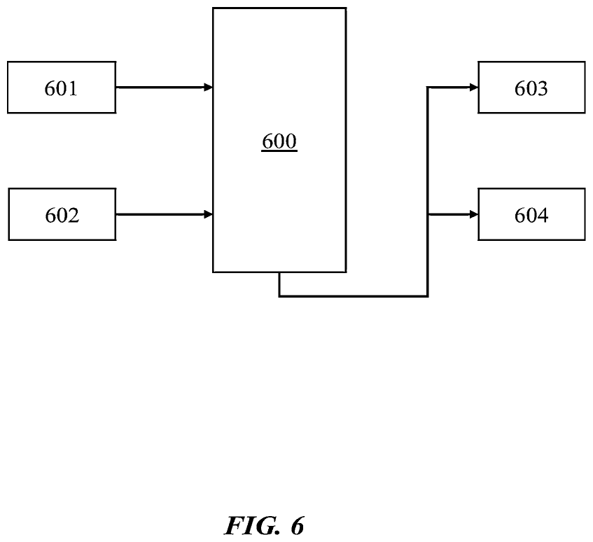

FIG. 6 shows a schematic representation of an example of a plasma process in accordance with the present disclosure. A feedstock 601 (e.g., natural gas and/or one or more other feedstocks described herein) 601 and energy (e.g., renewable electricity) 602 may be provided to the process (e.g., a plasma process as described elsewhere herein) 600. The process may produce one or more products, such as, for example, carbon black (a product) 603 and ammonia (a product) 604.

A process in accordance with the present disclosure (e.g., with biomethane feedstock) may provide a greater reduction in greenhouse gases than a process of making ammonia via electrolysis of water using renewable (e.g., solar) electricity followed by subsequent reaction of the hydrogen with nitrogen over a catalyst to make ammonia. For example, interestingly, yet not intuitively, the plasma process with biomethane can reduce greenhouse gases more than the process of making ammonia via the electrolysis of water using renewable electricity and then the subsequent reaction of the hydrogen with nitrogen over a catalyst to make ammonia. Because the hydrogen can be generated or collected from a biofuel, a process in accordance with the present disclosure (e.g., the plasma process) can have both substantially no (e.g., no) direct emissions of CO₂ and also effectively sequester CO₂ from the atmosphere in a carbonaceous product. This is a major advantage over any other process to make hydrogen. Greater than about 1% (e.g., over 1%) of global emissions of CO₂ are due to hydrogen production for the Haber-Bosch process to make ammonia. Innovative technologies such as the process(es) described herein (e.g., innovative technologies like the plasma process described herein) and the use of biomethane and other biofuels can make a meaningful impact on the global emissions of greenhouse gases.

Aspects of the present disclosure may be advantageously combined. For example, one or more CO₂ reduction and/or sequestration configurations described herein may be used in concert with each other and/or with, for example, one or more given conversion processes, such as, for example, the plasma technology (e.g., plasma process) described herein. For example, a process in accordance with the present disclosure may include a combination of biomethane (e.g., providing a feedstock at least in part comprising biomethane or biofuel, and/or operating a biofuel or biomethane process to provide such a feedstock), plasma technology (e.g., a plasma process as described elsewhere herein), and ammonia technology (e.g., operating on an ammonia (conversion) process to convert a co-product of the plasma technology to ammonia). Such a combined process may in some cases be operated in one location. The individual aspects/processes of the combined process may in some cases be working simultaneously. The term simultaneous in this instance may refer to substantially simultaneous (e.g., not all processes have to take place at the same time). For example, a biomethane process from, for example, sewage or from organic waste may operate some of the time but may be supplemented by delivery of biomethane from various other external sources. Likewise, some of the hydrogen used for the Haber-Bosch process may be temporarily stored prior to being provided to an ammonia reactor. Substantially all of the processes may occur simultaneously, but not necessarily at the exact same moment in time. Further, although a process may not be operated at a given time, a substantially similar overall configuration may be realized through, for example, storage or delivery of a given process output (e.g., delivery of biomethane when biomethane process is not in operation, or hydrogen storage for use in the ammonia reactor when plasma process is not in operation, etc.).

As described in greater detail elsewhere herein, processes in accordance with the present disclosure may be, or may use (e.g., be configured to use) or be coupled with green processes es (e.g., see FIG. 4 and FIG. 5). For example, biofuel or biomethane, and/or recyclable products, may be provided (e.g., directly and/or indirectly) as input to the processes described herein. Alternatively, or in addition, green processes may be incorporated through credits from a (e.g., resultant or underlying) green process such as, for example, biomethane production. The resultant carbonaceous output of such a green process may have digital carbon-14 credits. For example, the biomethane manufacturer may use the digestion process described elsewhere herein and then deliver the biomethane to the local pipeline and receive payment in excess of the normal cost of natural gas. The user of the biomethane may pay a credit that matches the price paid or is in excess of the price paid by the purchaser/seller of the biomethane that now acts as a middleman between the manufacturer of the biomethane and the user of the biomethane. The delivery vehicle of the biomethane may be the pipeline that connects the supplier to the purveyor of the technology using the biomethane; however, the individual methane molecules that the buyer of the biomethane receives may not have a given (e.g., proper) amount of carbon-14 as if the biomethane had been delivered by the actual producer of the biomethane. In some examples, this may be the most efficient method to deliver the biomethane to the final end user and may result in the least amount of CO₂ emitted into the atmosphere due to inefficiencies in the delivery of the biomethane to remote consumers of the biomethane. Biofuel or biomethane, or any other feedstock(s) with a ratio of carbon-14 atoms to carbon-12 atoms of, for example, greater than or equal to about 10\hat{ }−20 or higher (e.g., as described elsewhere herein), may be greater than or equal to about 0%, 1%, 5%, 10%, 15%, 20%, 25%, 30%, 35%, 40%, 45%, 50%, 55%, 60%, 65%, 70%, 75%, 80%, 85%, 90%, 95% or 100% of total feedstock provided to a process in accordance with the present disclosure. Alternatively, or in addition, the biofuel or biomethane, or any other feedstock(s) with a ratio of carbon-14 atoms to carbon-12 atoms of, for example, greater than or equal to about 10\hat{ }−20 or higher (e.g., as described elsewhere herein), may be, for example, less than or equal to about 100%, 95%, 90%, 85%, 80%, 75%, 70%, 65%, 60%, 55%, 50%, 45%, 40%, 35%, 30%, 25%, 20%, 15%, 10%, 5% or 1% of total feedstock provided to a process in accordance with the present disclosure. Fossil fuel-generated feedstock(s) (e.g., with a ratio of carbon-14 atoms to carbon-12 atoms of less than about 10\hat{ }−20) offset by carbon-14 credits may be greater than or equal to about 0%, 1%, 5%, 10%, 15%, 20%, 25%, 30%, 35%, 40%, 45%, 50%, 55%, 60%, 65%, 70%, 75%, 80%, 85%, 90%, 95% or 100% of total feedstock and/or of total non-fossil fuel-generated feedstock provided to a process in accordance with the present disclosure. Alternatively, or in addition, the fossil fuel-generated feedstock(s) (e.g., with a ratio of carbon-14 atoms to carbon-12 atoms of less than about 10\hat{ }−20) offset by carbon-14 credits may be, for example, less than or equal to about 100%, 95%, 90%, 85%, 80%, 75%, 70%, 65%, 60%, 55%, 50%, 45%, 40%, 35%, 30%, 25%, 20%, 15%, 10%, 5% or 1% of total feedstock and/or of total non-fossil fuel-generated feedstock provided to a process in accordance with the present disclosure.

As described in greater detail elsewhere herein, renewable energy (e.g., electricity to drive the conversion of feedstock(s) to product(s)) may be provided as input to processes described herein (e.g., see FIG. 4 and FIG. 6). For example, wind, solar and/or other renewable energy resources may provide electricity to the process (e.g., a plasma process as described herein). Alternatively, or in addition, renewable energy may be provided, for example, through renewable energy certificates (RECs) for the electricity (e.g., generated by fossil fuel) provided to the process, with 1 REC representing the environmental attributes of 1 MWh of renewable energy. Renewable energy (e.g., from renewable energy generators(s)) may be greater than or equal to about 0%, 1%, 5%, 10%, 15%, 20%, 25%, 30%, 35%, 40%, 45%, 50%, 55%, 60%, 65%, 70%, 75%, 80%, 85%, 90%, 95% or 100% of total energy (e.g., electricity) provided to a process in accordance with the present disclosure. Alternatively, or in addition, the renewable energy (e.g., from renewable energy generators(s)) may be, for example, less than or equal to about 100%, 95%, 90%, 85%, 80%, 75%, 70%, 65%, 60%, 55%, 50%, 45%, 40%, 35%, 30%, 25%, 20%, 15%, 10%, 5% or 1% of total energy (e.g., electricity) provided to a process in accordance with the present disclosure. Fossil fuel energy (e.g., from fossil fuel energy generator(s)) offset by RECs may be greater than or equal to about 0%, 1%, 5%, 10%, 15%, 20%, 25%, 30%, 35%, 40%, 45%, 50%, 55%, 60%, 65%, 70%, 75%, 80%, 85%, 90%, 95% or 100% of total energy and/or of total renewable energy (e.g., renewable electricity) provided to a process in accordance with the present disclosure. Alternatively, or in addition, the fossil fuel energy (e.g., from fossil fuel energy generator(s)) offset by RECs may be, for example, less than or equal to about 100%, 95%, 90%, 85%, 80%, 75%, 70%, 65%, 60%, 55%, 50%, 45%, 40%, 35%, 30%, 25%, 20%, 15%, 10%, 5% or 1% of total energy and/or of total renewable energy (e.g., renewable electricity) provided to a process in accordance with the present disclosure.

A carbonaceous product may have a ratio of carbon-14 atoms to carbon-12 atoms greater than about 3*10\hat{ }−13 (e.g., the ratio may be more than about 3*10\hat{ }−13:1 C¹⁴ to C¹²) and less than about 1.40*10\hat{ }−12 (e.g., the carbonaceous product may possess less than about 1.40*10\hat{ }−12:1 carbon-14 atoms compared to carbon-12 atoms). The carbonaceous product may be carbon black. Carbon atoms in the carbonaceous product may be exposed to temperatures in excess of about 1,000° C. or about 1,500° C. (e.g., as the reaction temperature) during the conversion process of biomethane and/or additive hydrocarbon feedstock to solid, carbonaceous product. Although physical carbon-14 may not be present in the carbonaceous product as made, the carbon-14 content of the carbonaceous product may be secured (e.g., achieved through purchase) of digital carbon-14 credits of biomethane. A green production process wherein for every ton of input natural gas in a green production process in accordance with the present disclosure, CO₂ emissions of the carbonaceous product and all other products may be reduced by more than about 3 tons when compared to incumbent processes. For every 1 ton of carbonaceous product that is produced in a green production process in accordance with the present disclosure, at least about 2.0 tons of CO₂ may be removed from the atmosphere and sequestered within a carbonaceous product and the carbon component (e.g., from the CO₂) may now be part of the as-manufactured carbonaceous product. Manufacture of the carbonaceous product (e.g., carbon black) may effectively sequester CO₂ out of the atmosphere. A combination of biomethane, plasma technology (e.g., plasma process as described herein), and ammonia technology (e.g., ammonia process such as an ammonia conversion process described herein) may be provided in one location (e.g., working or operating simultaneously). Wind energy or other renewable energy may be used to generate plasma in pyrolytic dehydrogenation of methane. Raw feed of tire crumb of less than about 10 mm by 10 mm size may be provided into the plasma process as a co-feed with biomethane, biofuel and/or natural gas. A method of converting tires and carbon black to methane may be provided. The method may further comprise using the methane to produce carbonaceous product. The carbonaceous product may be carbon black. A rubber article may have a ratio of carbon-14 atoms to carbon-12 atoms from about 3*10\hat{ }−13 to about 1.40*10\hat{ }−12 (e.g., the rubber article may possess from about 3*10\hat{ }−13 to about 1.40*10\hat{ }−12 carbon-14 atoms for every 1 carbon-12 atom). A tire may have a ratio of carbon-14 atoms to carbon-12 atoms from about 3*10\hat{ }−13 to about 1.40*10\hat{ }−12 (e.g., the tire may possess from about 3*10\hat{ }−13 to about 1.40*10\hat{ }−12 carbon-14 atoms for every 1 carbon-12 atom). A feed of biomethane may possess about 60% or greater content of methane derived from a biological source; the remainder of gas by volume may be impurities from digestion process or co-feedstocks that may or may not be bio-based.

In another aspect, the present disclosure provides a carbonaceous product. The carbonaceous product may have a ratio of carbon-14 atoms to carbon-12 atoms as described elsewhere herein. For example, the carbonaceous product may have a ratio greater than about 3*10\hat{ }−13. The carbonaceous product may have a carbon content of at least about 90, 91, 92, 93, 94, 95, 95.5, 96, 96.5, 97, 97.5, 98, 98.5, 99, 99.5, 99.9, 99.95, 99.99, or more percent. The carbonaceous product may have a carbon content of at most about 99.99, 99.95, 99.9, 99.5, 99, 98.5, 98, 97.5, 97, 96.5, 96, 95.5, 95, 94, 93, 92, 91, 90, or less percent. For example, the carbonaceous product can have a carbon content of greater than about 97% by weight. The carbonaceous product may have a carbon content in a range as defined by any two of the proceeding values. For example, the carbonaceous product can have a carbon content of between about 95% and 99%. The carbonaceous product may comprise graphitic rings. The graphitic rings may comprise polycyclic aromatic rings. The polycyclic aromatic rings may comprise at least about 5, 6, 7, 8, 9, 10, 11, 12, 13, 14, 15, or more rings. The polycyclic aromatic rings may comprise at most about 15, 14, 13, 12, 11, 10, 9, 8, 7, 6, 5, or fewer rings. For example, the polycyclic aromatic rings may comprise at least about 8 aromatic rings. The graphitic rings may possess properties similar to those of graphite. The graphitic rings may not be present in naturally produced biomass. For example, a plant-based biomass may not comprise graphitic rings. The carbonaceous product may comprise carbon black as described elsewhere herein. The carbonaceous product may be solid. For example, the carbonaceous product can be a solid carbon containing product as opposed to a gaseous product.

In another aspect, the present disclosure may provide a method of forming a carbonaceous product. A feedstock and a heated gas may be provided. The feedstock may have a ratio of carbon-14 atoms to carbon-12 atoms greater than about 3*10\hat{ }−13. The feedstock and the heated gas may be mixed to form the carbonaceous product. The carbonaceous product may have a ratio of carbon-14 atoms to carbon-12 atoms greater than about 3*10\hat{ }−13. The carbonaceous product may have a carbon content as described elsewhere herein. For example, the carbonaceous product may have a carbon content of at least about 97% by weight. The carbonaceous product may have graphitic rings. The feedstock may have a ratio of carbon-14 to carbon-12 as described elsewhere herein. The carbonaceous product may be as described elsewhere herein. For example, the carbonaceous product may be carbon black.

Carbon atoms in the carbonaceous product may be exposed to temperatures of at least about 500, 750, 1,000, 1,250, 1,500, 1,750, 2,000, 2,250, 2,500, 2,750, 3,000, or more degrees Celsius during conversion of the feedstock to the carbonaceous product. Carbon atoms in the carbonaceous product may be exposed to temperature of at most about 3,000, 2,750, 2,500, 2,250, 2,000, 1,750, 1,500, 1,250, 1,000, 750, 500, or less degrees Celsius during conversion of the feedstock to the carbonaceous product. Carbon atoms in the carbonaceous product may be exposed to a temperature range as defined by any two of the proceeding values during conversion of the feedstock to the carbonaceous product. For example, the carbon atoms can be exposed to a temperature from about 1,500 to about 3,000 degrees Celsius during conversion of the feedstock to the carbonaceous product.

The conversion of the feedstock may comprise a conversion of one or more of biomethane, biofuels, unprocessed biological materials (e.g., biological materials as harvested or collected), an additive hydrocarbon feedstock (e.g., an addition of a non-renewable hydrocarbon), or the like, or any combination thereof to the carbonaceous product. For example, a biomethane feedstock can be converted directly to the carbonaceous feedstock. In this example, all of the carbonaceous feedstock can be produced from the biomethane. In another example, a mixture of the biomethane and natural gas derived from fossil fuels can be used together as the feedstock. In this example, the carbonaceous product may have a lower carbon-14 to carbon-12 ratio than a carbonaceous product made only from biomethane, as the presence of the fossil fuel derived natural gas can reduce the amount of carbon-14 present in the combined feedstock.

For each ton of input natural gas (e.g., fossil fuel derived natural gas), carbon dioxide emissions derived from the production of the carbonaceous product and all other products of a production process (e.g., other products made using the same input natural gas) can be reduced by at least about 0.1, 0.5, 1, 1.5, 2, 2.5, 3, 3.5, 4, 4.5, 5, 5.5, 6, 7, 8, 9, 10, or more tons as compared to an incumbent process for producing the carbonaceous product and the other products. For each ton of input natural gas (e.g., fossil fuel derived natural gas), carbon dioxide emissions derived from the production of the carbonaceous product and all other products of a production process (e.g., other products made using the same input natural gas) can be reduced by at most about 10, 9, 8, 7, 6, 5, 5.5, 5, 4.5, 4, 3.5, 3, 2.5, 2, 1.5, 1, 0.5, or less tons as compared to an incumbent process for producing the carbonaceous product and the other products. The incumbent process may be as described elsewhere herein. The incumbent process may be, for example, a furnace production of the carbonaceous product. The method may comprise sequestering carbon dioxide within the carbonaceous product such that a ratio of carbon dioxide sequestered to carbonaceous product is at least about 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, or more.

The mixing the feedstock and the heated gas to form the carbonaceous product may be performed substantially free of atmospheric oxygen, free sulfur, metal ions, atmospheric nitrogen, or the like or any combination thereof. Substantially free may be where an impurity is present at a concentration of less than at most about 25%, 24%, 23%, 22%, 21%, 20%, 19%, 18%, 17%, 16%, 15%, 14%, 13%, 12%, 11%, 10%, 9%, 8%, 7%, 6%, 5%, 4.5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm. The mixing the feedstock and the heated gas to form the carbonaceous product may be performed with the aid of electrical heating as described elsewhere herein. The mixing the feedstock and the heated gas to form the carbonaceous product may be performed with the aid of a plasma generator. For example, the feedstock and the heated gas can be mixed in an electric plasma heated chamber.

In another aspect, the present disclosure provides a method of determining an adjusted ratio of carbon-14 to carbon-12. The method may comprise providing a feedstock and a heated gas. The feedstock and the heated gas may be mixed to form the carbonaceous product. At least one computer processor may be used to calculate the adjusted ratio of carbon-14 to carbon-12. The adjusted ratio may comprise a combination of a physical ratio of carbon-14 to carbon-12 atoms present within the carbonaceous product and digital carbon-14 credits of biomethane.

The feedstock and the heated gas may be as described elsewhere herein. Though described above with reference to biomethane, the methods of the present disclosure may be used with any renewable carbon feedstock as described elsewhere herein. The calculation of an adjusted ratio may be described further in Example 5. The adjusted ratio of carbon-14 to carbon-12 may be as described elsewhere herein. For example, the adjusted ratio can be at least about 3*10\hat{ }−13.

In another aspect, the present disclosure provides a production process. The production process may comprise a biomethane process, a plasma process, and an ammonia process. The biomethane process, the plasma process, and the ammonia process may be in one location. The one location may be a location with a diameter of at most about 25, 20, 15, 10, 9, 8, 7, 6, 5, 4, 3, 2, 1, 0.5, 0.25, or less miles. For example, the biomethane process can be housed in a first location, while the plasma process and the ammonia process can be housed at a second location less than a mile away. In another example, the biomethane process, the plasma process, and the ammonia process can each be housed at different locations less than 0.5 miles from one another. In another example, the biomethane process, the plasma process, and the ammonia process can be collocated in a single facility. The biomethane process, the plasma process, and the ammonia process may operate simultaneously. For example, each process can be running at the same time as the other processes. The biomethane process may produce biomethane. The plasma process may consume the biomethane produced by the biomethane process and produce hydrogen, a carbonaceous product, or the like, or any combination thereof. The ammonia process can consume the hydrogen produced by the plasma process and produce ammonia comprising the hydrogen. For example, the biomethane process can generate biomethane that is fed into the plasma process, which in turn can produce hydrogen that is fed into the ammonia process. In this example, the three processes can occur simultaneously using the feeds from each process to support the others. Waste heat may be shared between one or more of the biomethane process, the plasma process, and the ammonia process. For example, the plasma process can produce waste heat that can be used to heat the biomethane and the ammonia processes. The use of the waste heat can improve the efficiency of the combined production process as compared to performing the processes individually.

In another aspect, the present disclosure provides a raw feed of tire crumb. The tire crumb of the raw feed of tire crumb may have a dimension on a side of at most about 50, 40, 30, 25, 20, 19, 18, 17, 16, 15, 14, 13, 12, 11, 10, 9, 8, 7, 6, 5, 4, 3, 2, 1, or less millimeters. For example, the tire crumb may have a size of less than about 10 millimeters by 10 millimeters. The raw feed of tire crumb may be provided into a plasma process as a co-feed with biomethane, biofuel, natural gas, or the like, or any combination thereof.

The plasma process may produce a carbonaceous product (e.g., carbon black). For example, a plasma process to produce carbon black as described elsewhere herein may use a co-feed of tire crumb and biomethane to produce the carbon black. In this example, the tire crumb can be thermally decomposed into a hydrocarbon gas, which can in turn be used with the co-feed to form the carbon black. In this way, the tire crumb can be recycled to produce a carbonaceous product, diverting the tire crumb from other waste streams. Due to the difficulty in recycling tires, the use of tires as a feedstock for a plasma process represents an improvement in efficiency, cost, and environmental impact over other tire disposal processes.

In another aspect, the present disclosure provides a method of processing, which may comprise converting one or more tires and carbon black into methane. The carbon black may be compounded within the tires. For example, the carbon black can be mixed with the rubber of the tire during the formation of the tire to improve the wear resistance of the tire. In this example, the carbon black may be integral to the tire and difficult to remove from the rubber. In some cases, the one or more tires and carbon black can be converted into methane, volatile organics, semi-volatile organics, or the like, or any combination thereof. A volatile organic may be an organic (e.g., a carbon containing) molecule with a vapor pressure sufficient to become gaseous a temperature and pressure of the conversion. Examples of volatile organics include, but are not limited to, aromatic compounds (e.g., benzene, toluene, xylenes, anthracene, etc.), alkanes (e.g., ethane, propanes, butanes, hexanes, octanes, etc.), cyclic compounds (e.g., non-aromatic cyclic carbon containing compounds), or the like. A non-volatile organic may be an organic (e.g., carbon containing) molecule that remains solid and/or liquid at a temperature and pressure of the conversion. For example, coke may not be volatile in the processing. The non-volatile organics may decompose into volatile organics. For example, a charcoal derived from the tire can be converted to volatile organics under the heat of the processing. The carbon black may not re-volatilize. For example, the carbon black may not be converted into methane depending on the temperature and residence time of the carbon black in the processing. In some cases, the carbon black can be heated at a high (e.g., greater than about 2,000° C.) for an extended period of time (e.g., greater than about 30 minutes) to slowly re-volatilize the carbon black into methane, volatile organics, or a combination thereof. In some cases, the carbon black may be recovered from the process and recycled. For example, the tires can be converted to methane, while the carbon black is not converted to methane and instead recycled.

The converting may comprise use of a plasma process as described elsewhere herein. For example, the tires and carbon black can be fed into the plasma process at a temperature of at least about 1,500 degrees Celsius to produce the methane. The rubber of the tires may convert to methane more readily than the carbon black. For example, the feed of tires and carbon black can produce methane with a majority of carbon atoms that were previously in the tires.

The methane may be used as a feedstock as described elsewhere herein. For example, the methane can be used to produce a carbonaceous product (e.g., carbon black). The carbonaceous product may be produced substantially free of atmospheric oxygen as described elsewhere herein. The carbonaceous product may be produced with the aid of electrical heating (e.g., a plasma generator) as described elsewhere herein.

In another aspect, the present disclosure provides a polymer article having a ratio of carbon-14 atoms to carbon-12 atoms greater than about 3*10\hat{ }−13. The polymer article may comprise a carbonaceous product. For example, the polymer article can be compounded with carbon black. The rubber article may be a tire, a rubber article, a plastic article, or the like, or any combination thereof. For example, a tire generated from natural rubber and carbon black made according to the methods of the present disclosure can have a total ratio of carbon-14 to carbon-12 atoms of greater than about 3*10\hat{ }−13.

In another aspect, the present disclosure provides a feed of biomethane. The feed of biomethane may comprise greater than or equal to about 60% by volume of methane derived from a biological source. A remainder of the feed of biomethane may comprise impurities from a digestion process and/or one or more co-feedstocks. The feed of biomethane may be used to produce a carbonaceous product as described elsewhere herein. The carbonaceous product may not comprise the impurities from the digestion process. For example, the carbonaceous product may not comprise sulfur from a sulfur containing impurity. The impurities may be removed from the feedstock (e.g., the impurities may be filtered away from the feedstock prior to use of the feedstock to form a carbonaceous product). The impurities may be inert to the formation of the carbonaceous product. For example, a carbon dioxide impurity may not impact the formation of a carbonaceous product. In this example, the carbon dioxide impurity can reduce efficiency of a carbonaceous product production process by providing additional mass to heat that does not in turn participate in the reaction. In this example, removal of the inert impurity can improve efficiency and reduce costs. The one or more co-feedstocks may comprise one or more bio-based co-feedstocks, one or more non bio-based co-feedstocks, or a combination thereof.

The following examples are illustrative of certain systems and methods described herein and are not intended to be limiting.

### EXAMPLES

### Example 1

CO₂ is pulled out of the atmosphere and into a bio-organism, such as, for example, a plant or tree. That plant or tree then produces a digestible material. At some point before it is fully digested by the environment, this material is digested in an anaerobic digester or similar, and the resultant biomethane or biofuel is provided to a plasma process in accordance with the present disclosure. As a result of the plasma process, the carbon that was previously in the atmosphere is now in the form of carbon black and further hydrogen that was in the biosphere is now in the form of pure hydrogen gas. The carbon black may be sold, and the hydrogen may either be sold for its energy value, or provided or coupled to one or more other uses (e.g., as described elsewhere herein). For example, the hydrogen may be used make another chemical such as, for example, ammonia which has a variety of uses, including as fertilizer in agriculture.

### Example 2

A tire, comprising (i) 30% by weight natural rubber from the Hevea brasiliensis or rubber tree or the like that is significantly from a plant or tree, along with (ii) 30% by mass of biomethane- or biofuel-derived carbon black produced in accordance with the present disclosure, is recycled. The tire is recycled in such a way that it is used as a feedstock for a process to make carbon black in accordance with the present disclosure (e.g., a plasma process). The resultant carbon black has a ratio of carbon-14 atoms to carbon-12 atoms of about 80.1*10\hat{ }−13 due to the dilution of the other components of the tire that were derived from fossil fuels.

### Example 3

This example describes advantage(s) of a plasma process in accordance with the present disclosure over incumbent furnace process for carbon black, and steam methane reforming (SMR) and Haber-Bosch process for ammonia production.

Furnace Process:

For 1.06 million tons of carbon black produced, 2.6 million tons of CO₂ are emitted into the atmosphere. This equates to 2.45 tons of CO₂/ton carbon black. See Orion Engineered Carbons 2018 Sustainability Report, incorporated by reference herein with respect to relevant portions therein.

Haber-Bosch with SMR Ammonia:

Global production of ammonia of 157.3 million metric tons in 2010 is associated with CO₂ emissions of 451 million tons in that same year. This is the equivalent of 2.87 tons of CO₂/ton NH₃. See C&EN “Industrial ammonia production emits more CO₂ than any other chemical-making reaction. Chemists want to change that” Jun. 15, 2019 Volume 97 Issue 24, incorporated by reference herein with respect to relevant portions therein. That being said, 1 ton of CO₂ is generated per ton of ammonia to achieve the temperatures and pressures of the Haber-Bosch process. This is the equivalent of 1.87 tons CO₂/ton NH₃.

Plasma Process:

Wind energy used for electricity in the plasma process generates zero CO₂. CH₄ from biomethane equates to the sequestering of 3.67 ton of CO₂ per ton of carbon, such as, for example, carbon black, if full theoretical yield of carbon is achieved while utilizing renewable resources.

Tons of CO₂ emitted total for incumbent processes of one ton of carbon black and one ton of ammonia is 4.32 tons. For a plasma process that makes 2 moles of H₂, the amount of carbon dioxide emitted goes up to 5.28 tons for the incumbent processes. If tons of CO₂ sequestered due to the use of biomethane is also taken into account, then the differential is increased to 5.28 tons plus 3.67 tons of CO₂, or 8.95 tons of CO₂, as a differential between the incumbent processes and the plasma process that utilizes renewable energy and biomethane as described herein.

### Example 4

An example of a plasma process in accordance with the present disclosure is schematically illustrated in FIG. 6. CO₂ for this process is as described in Example 3.

An example of a conventional carbon black process is schematically illustrated in FIG. 7. From 2014-2018, U.S. carbon black production by conventional carbon black process is associated with average Scope 1 GHG emissions of 2.34 TCO₂e/TCB. See Notch Carbon Black World Data Book 2019, and Environmental Protection Agency (EPA) Greenhouse Gas Reporting Program (GHGRP) 2018 Greenhouse Gas Emissions from Large Facilities website, Facility Level Information on GreenHouse gases Tool (FLIGHT), each of which is incorporated by reference herein with respect to relevant portions therein.

An example of a conventional ammonia process is schematically illustrated in FIG. 8. From 2013-2017, U.S. ammonia production by conventional ammonia process is associated with average Scope 1 GHG emissions of 2.24 TCO₂e/TNH₃. See U.S. Geological Survey, Mineral Commodity Summaries, February 2019, page 116, and Environmental Protection Agency (EPA) Greenhouse Gas Reporting Program (GHGRP) Industrial Profile: Chemicals Sector (non-Fluorinated), September 2019, page 11, each of which is incorporated by reference herein with respect to relevant portions therein.

### Example 5

Carbonaceous products may have an adjusted ratio of carbon-14 to carbon-12 atoms even if a physical ratio of carbon-14 to carbon-12 atoms is different from the adjusted ratio. For example, a feedstock used to generate a carbonaceous product can be a combination of feedstocks sourced from different suppliers. A first supplier can generate the feedstock via a fossil fuel route, and the resulting feedstock can have a low ratio of carbon-14 to carbon-12 atoms. A second supplier can generate the feedstock via a renewable route (e.g., digestion of plants, etc.), and the resulting feedstock can have a high ratio of carbon-14 to carbon-12 atoms. The first and second suppliers can supply their respective feedstocks to a pipeline, where the feedstocks are mixed, and the resultant mixture has a lower ratio of carbon-14 to carbon-12 atoms (e.g., less than 3*10\hat{ }−13). The mixture may comprise more of the first feedstock than the second feedstock, which may result in the lower ratio.

The supplier of the renewable feedstock can provide environmental credits that denote the renewable nature of the feedstock. For example, the environmental credits can be digital credits related to the renewable nature of the feedstock. Examples of digital credits include, but are not limited to, certificates, non-fungible tokens, other blockchain based tokens, or the like. The supplier of the renewable feedstock can exchange or sell the credits. The recipient of the credits can, in turn, attest that they have purchased renewable feedstock, even if the feedstock delivered from the pipeline contains a mixture of renewable and non-renewable feedstocks.

The feedstocks can then be used to generate a carbonaceous product. The carbonaceous product can have a physical ratio of carbon-14 to carbon-12 atoms that is less than the ratio found in the renewable feedstock. To calculate an adjusted ratio of carbon-14 to carbon-12 atoms, the physical ratio can be determined, and the ratio can be adjusted using any credits purchased by the producer of the carbonaceous product. For example, one ton of carbonaceous product with a physical ratio of carbon-14 to carbon-12 atoms of 5*10\hat{ }−14 produced by a producer with the equivalent of one ton of renewable feedstock credits at a ratio of carbon-14 to carbon-12 atoms of 1.5*10\hat{ }−13 can have an adjusted ratio of 1*10\hat{ }−13.

Systems and methods of the present disclosure may be combined with or modified by other systems and/or methods, such as chemical processing and heating methods, chemical processing systems, reactors and plasma torches described in U.S. Pat. Pub. No. US 2015/0210856 and Int. Pat. Pub. No. WO 2015/116807 (“SYSTEM FOR HIGH TEMPERATURE CHEMICAL PROCESSING”), U.S. Pat. Pub. No. US 2015/0211378 (“INTEGRATION OF PLASMA AND HYDROGEN PROCESS WITH COMBINED CYCLE POWER PLANT, SIMPLE CYCLE POWER PLANT AND STEAM REFORMERS”), Int. Pat. Pub. No. WO 2015/116797 (“INTEGRATION OF PLASMA AND HYDROGEN PROCESS WITH COMBINED CYCLE POWER PLANT AND STEAM REFORMERS”), U.S. Pat. Pub. No. US 2015/0210857 and Int. Pat. Pub. No. WO 2015/116798 (“USE OF FEEDSTOCK IN CARBON BLACK PLASMA PROCESS”), U.S. Pat. Pub. No. US 2015/0210858 and Int. Pat. Pub. No. WO 2015/116800 (“PLASMA GAS THROAT ASSEMBLY AND METHOD”), U.S. Pat. Pub. No. US 2015/0218383 and Int. Pat. Pub. No. WO 2015/116811 (“PLASMA REACTOR”), U.S. Pat. Pub. No. US2015/0223314 and Int. Pat. Pub. No. WO 2015/116943 (“PLASMA TORCH DESIGN”), Int. Pat. Pub. No. WO 2016/126598 (“CARBON BLACK COMBUSTABLE GAS SEPARATION”), Int. Pat. Pub. No. WO 2016/126599 (“CARBON BLACK GENERATING SYSTEM”), Int. Pat. Pub. No. WO 2016/126600 (“REGENERATIVE COOLING METHOD AND APPARATUS”), U.S. Pat. Pub. No. US 2017/0034898 and Int. Pat. Pub. No. WO 2017/019683 (“DC PLASMA TORCH ELECTRICAL POWER DESIGN METHOD AND APPARATUS”), U.S. Pat. Pub. No. US 2017/0037253 and Int. Pat. Pub. No. WO 2017/027385 (“METHOD OF MAKING CARBON BLACK”), U.S. Pat. Pub. No. US 2017/0058128 and Int. Pat. Pub. No. WO 2017/034980 (“HIGH TEMPERATURE HEAT INTEGRATION METHOD OF MAKING CARBON BLACK”), U.S. Pat. Pub. No. US 2017/0066923 and Int. Pat. Pub. No. WO 2017/044594 (“CIRCULAR FEW LAYER GRAPHENE”), U.S. Pat. Pub. No. US20170073522 and Int. Pat. Pub. No. WO 2017/048621 (“CARBON BLACK FROM NATURAL GAS”), Int. Pat. Pub. No. WO 2017/190045 (“SECONDARY HEAT ADDITION TO PARTICLE PRODUCTION PROCESS AND APPARATUS”), Int. Pat. Pub. No. WO 2017/190015 (“TORCH STINGER METHOD AND APPARATUS”), Int. Pat. Pub. No. WO 2018/165483 (“SYSTEMS AND METHODS OF MAKING CARBON PARTICLES WITH THERMAL TRANSFER GAS”), Int. Pat. Pub. No. WO 2018/195460 (“PARTICLE SYSTEMS AND METHODS”), Int. Pat. Pub. No. WO 2019/046322 (“PARTICLE SYSTEMS AND METHODS”), Int. Pat. Pub. No. WO 2019/046320 (“SYSTEMS AND METHODS FOR PARTICLE GENERATION”), Int. Pat. Pub. No. WO 2019/046324 (“PARTICLE SYSTEMS AND METHODS”), Int. Pat. Pub. No. WO 2019/084200 (“PARTICLE SYSTEMS AND METHODS”), and Int. Pat. Pub. No. WO 2019/195461 (“SYSTEMS AND METHODS FOR PROCESSING”), each of which is entirely incorporated herein by reference.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A carbonaceous product having a ratio of carbon-14 atoms to carbon-12 atoms greater than about 3*10\hat{ }−13 and a carbon content of at least about 97% by weight.

2. The carbonaceous product of claim 1, wherein the carbonaceous product is carbon black.

3. The carbonaceous product of claim 1, wherein the carbonaceous product is solid.

4. The carbonaceous product of claim 1, wherein the carbonaceous product comprises graphitic rings.

5. A carbonaceous product having a ratio of carbon-14 atoms to carbon-12 atoms greater than about 3*10\hat{ }−13 and comprising graphitic rings.

6. The carbonaceous product of claim 5, wherein the carbonaceous product is carbon black.

7. The carbonaceous product of claim 5, wherein the carbonaceous product is solid.

8. A method of forming a carbonaceous product, comprising
(a) providing a feedstock and a heated gas, wherein the feedstock has a ratio of carbon-14 atoms to carbon-12 atoms greater than about 3*10\hat{ }−13; and
(b) mixing the feedstock and the heated gas to form the carbonaceous product, wherein the carbonaceous product has a ratio of carbon-14 atoms to carbon-12 atoms greater than about 3*10\hat{ }−13 and a carbon content of at least about 97% by weight.

9. The method of claim 8, wherein the carbonaceous product is carbon black.

10. The method of claim 8, wherein carbon atoms in the carbonaceous product are exposed to temperatures in excess of about 1,000° C. during conversion of the feedstock to the carbonaceous product.

11. The method of claim 10, wherein the conversion of the feedstock comprises conversion of biomethane or additive hydrocarbon feedstock to the carbonaceous product.

12. The method of claim 8, wherein for every ton of an input natural gas, carbon dioxide (CO₂) emissions of carbonaceous product and all other products of a production process are reduced by more than about 3 tons compared to incumbent processes for producing the carbonaceous product and all other products.

13. The method of claim 8, further comprising sequestering CO₂ within the carbonaceous product such that a ratio of CO₂ sequestered to carbonaceous product is at least about 2:1.

14. The method of claim 8, wherein (b) is performed substantially free of atmospheric oxygen.

15. The method of claim 8, wherein (b) is performed with the aid of electrical heating.

16. The method of claim 8, wherein (b) is performed with the aid of a plasma generator.

17.-39. (canceled)

40. The method of claim 8, further comprising using at least one computer processor to calculate an adjusted ratio of the carbon-14 atoms to the carbon-12 atoms.

41. The method of claim 14, wherein the adjusted ratio of the carbon-14 atoms to the carbon-12 atoms comprises (i) the ratio of the carbon-14 atoms to the carbon-12 atoms present within the carbonaceous product and (ii) one or more digital carbon-14 credits of biomethane,

42. The method of claim 8, wherein the feedstock comprises methane.

43. The method of claim 42, further comprising, prior to (a), producing the methane.
